(19) United States
(12) Patent Application Publication
(10) Pub. No.: US 2018/0213273 A1
(43) Pub. Date: Jul. 26, 2018

(54) Computing System and Process for Digital Video Data Management and Scheduling

(71) Applicant: Bitcine Technologies Incorporated, Toronto (CA)

(72) Inventor: Colin Maxwell Carter, Toronto (CA)

(73) Assignee: Bitcine Technologies Incorporated, Toronto (CA)

(21) Appl. No.: 15/878,150

(22) Filed: Jan. 23, 2018

Related U.S. Application Data
(60) Provisional application No. 62/449,779, filed on Jan. 24, 2017.
(60) Provisional application No. 62/449,802, filed on Jan. 24, 2017.

(30) Foreign Application Priority Data
Jan. 24, 2017 (CA) 2955930

(51) Int. Cl. H04N 21/262; H04N 21/431; H04N 21/214; H04N 21/414; H04N 21/266; H04N 21/258; H04N 21/854; H04N 21/8352

(52) U.S. Cl. CPC H04N 21/26258; H04N 21/4312; H04N 21/2143; H04N 21/41415; H04N 21/26613; H04L 51/22; H04N 21/85406; H04N 21/8352; H04N 21/26241; H04N 21/26606; H04N 21/25825

(57) ABSTRACT

A film festival may play hundreds of films. Managing the variances in technical requirements for the film data to accommodate different screens and projectors, transferring the film data, and the coordinating digital communication from potentially hundreds of filmmakers may be technically challenging. A server system is provided to manage the transfer of the digital film data, the scheduling and assignment of film data with specific projector devices, and to validate the film data. The server system also provides graphical user interfaces (GUIs) to the film festival organizer to manage a print ticket process and the scheduling process, and GUIs to a filmmaker to facilitate transferring of the film data.

### CROSS-REFERENCE TO RELATED APPLICATIONS

The present application claims priority to U.S. Provisional Patent Application No. 62/449,779, filed on Jan. 24, 2017 and titled “Computing System and Process for Digital Video Data Management and Scheduling”, Canadian Patent Application No. 2,955,930, filed on Jan. 24, 2017 and titled “Computing System and Process for Digital Video Data Management and Scheduling”, and U.S. Provisional Patent Application No. 62/449,802, filed on Jan. 24, 2017 and titled “Computing System for Automatically Validating and Managing Data of Digital Cinema Packages”, the entire contents of which are herein incorporated by reference.

### TECHNICAL FIELD

The following relates to digital video data management and scheduling.

### DESCRIPTION OF THE RELATED ART

A film festival is an organized, extended presentation of films in one or more cinemas or screening venues, usually in a single city or region. There are many technical considerations in organizing a film festival, including communication, scheduling, management of video data, and coordinating the video data in view of the technical specifications of a screening venue.

For example, a film festival may screen or play hundreds of films over the course of the festival. Organizing the film festival is difficult due to the number of films, the variances in technical requirements for the film to accommodate different screens and projectors, and transfer of the film data, and the management of digital communication from potentially hundreds of filmmakers. These tasks and computations relate to print traffic management in the film festival industry.

In particular, print traffic data management typically includes one or more of the following technical processes: updating a print tracking database; tracking shipping and receiving of all films and videos, including origin, carrier, tracking number, theater assignment and post-festival destination; assigning films to be played on certain projection machines at the cinema venues; electronic communication of print status and usage during a film festival; and validating film data.

Current computer systems and databases are not configured to efficiently manage the above technical processes.

### BRIEF DESCRIPTION OF THE DRAWINGS

Embodiments will now be described by way of example only with reference to the appended drawings wherein:

FIG. 1 is a schematic diagram of an example computing system for digital film data management and scheduling film data.

FIG. 2 is a schematic diagram of an example computing architecture of a server system used for digital film data management and scheduling of the same.

FIG. 3 is a schematic diagram of an example data organized and stored within the server system.

FIG. 4a is a flow diagram of example computer executable instructions for generating a unique identifier and a corresponding email account.

FIG. 4b is another example of generating a unique identifier and a corresponding email account using a film ID and festival organizer ID.

FIGS. 5a, 5b and 5c are flow diagrams of example computer executable instructions for acquiring digital film data from a filmmaker.

FIGS. 6a to 6d are example graphical user interfaces (GUIs) of a web portal used by a film festival organizer to obtain film data. FIGS. 6e to 6g are example GUIs of a wizard used by a filmmaker to transfer film data to a film festival organizer. FIG. 6h is a GUI in the web portal that displays a list of films to be shown at the festival, including the related status information of each film.

FIGS. 7a to 7f are example GUIs used by a film festival organizer to schedule films for a film festival.

FIG. 8 is a flow diagram of example computer executable instructions for providing and operating a scheduling GUI.

FIG. 9 is a flow diagram of example computer executable instructions for automatically updating a schedule based on a pre-event or a post-event, or both, relative to a given film viewing.

FIG. 10 is a flow diagram of example computer executable instructions for automatically updating a schedule based on a change to a given film's time length.

FIG. 11 is a flow diagram of example computer executable instructions for grouping films within a scheduling GUI.

FIG. 12a is a flow diagram of example computer executable instructions for automatically generating an electronic schedule of films.

FIG. 12b is a flow diagram of example computer executable instructions for another embodiment of automatically generating an electronic schedule of films.

FIG. 13 is a schematic diagram of a data structure of a Digital Cinema Package.

FIG. 14 is a flow diagram of example computer executable instructions for automatically validating or rejecting a DCP.

FIG. 15 is a flow diagram of example computer executable instructions for encrypting a DCP and managing a corresponding Key Delivery Message (KDM).

FIG. 16 is a flow diagram of example computer executable instructions for managing a KDM for an encrypted DCM.

FIG. 17 is a flow diagram of example computer executable instructions for automatically validating or invalidating a KDM.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures and components have not been described in detail so as not to obscure the example embodiments described herein. Also, the description is not to be considered as limiting the scope of the example embodiments described herein.

Digital film data is currently formatted in various forms, including BluRay, DVD, QuickTime files, and Digital Cinema Package (DCP). The digital film data itself can be transmitted over a data network, such as a satellite network or the Internet, or both. The digital film data can also be stored on a computer readable medium (e.g. a disc, a hard drive, a solid-state drive, etc.) and then physically shipped from one location to another.

It is also herein recognized that a cinema may have different theater screens, each with their own projector device, and that each projector has specific data requirements that can differ from other projector devices.

In a film festival, it is herein recognized that one or more cinemas may be used to display, also called “screen”, the films. Current computing systems and processes are not configured to manage the above variations of technical requirements, especially for a larger number of films (e.g. hundreds of films).

It is also recognized that current computing systems use general purpose email interfaces, calendar interfaces, and related computing systems (e.g. Gmail, Outlook, etc.) to manage electronic communications amongst potentially hundreds of filmmakers. However, these general purpose email interfaces, calendar interfaces, and related computing systems do not allow for data to be organized to take into account the above variations and technical requirements of digital film data technology, the projector technology, and the implementation of a film festival. The disparate computing systems and software technology typically used by a film festival organizer leads to overall technical inefficiencies and increased technical errors.

For example, a specific data format is requested, but a wrong data format for a film is provided and, therefore, it cannot be screened. In another example, a digital film's data format is provided as requested, but the digital film is assigned and scheduled to play via an incompatible projector device or screen. In another example, digital film submissions are confused with one another due to miscommunication.

It is therefore desirable to provide a computing system with processes configured to address at least one of the above technical difficulties or requirements. It another aspect, it is desirable to provide a computing system with processes configured to simultaneously address the combination of the above technical difficulties or requirements.

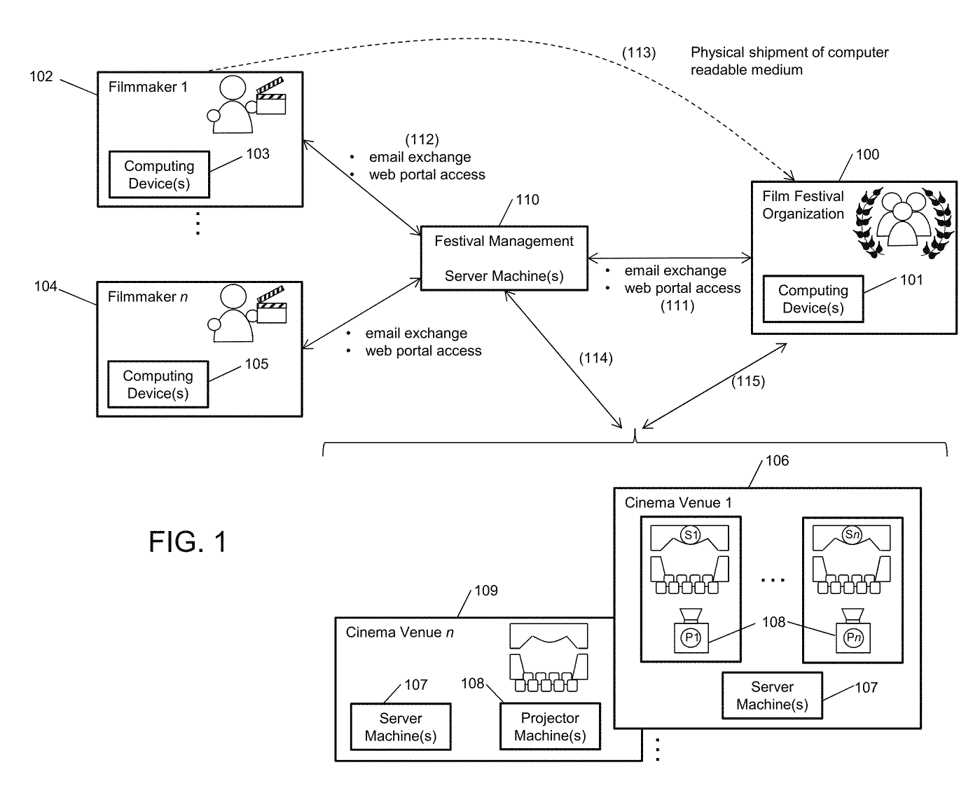

Turning to FIG. 1, an example of a computing system is provided in which the computing devices or machines of a film festival organizer 100, and one or more filmmakers 102, 104, one or more cinema venues 106, 109 are in electronic communication with each other via one or more festival management server machines 110, also called the festival management server system.

In particular, a film festival organizer 100 may be associated with one or more computing devices (e.g. laptops, tablets, desktop computers, mobile devices, etc.) 101 that exchanges digital data with the festival management server system 110. It will be appreciated that while one film festival organizer is shown, multiple film festival organizers may simultaneously interact with the server system 110.

Each filmmaker 102, 104 respectively is associated with one or more computing devices (e.g. laptops, tablets, desktop computers, mobile devices, etc.) 103, 105 that each exchange digital data with the festival management server system 110.

A cinema venue 106 is associated with one or more of its own server machines 107 and one or more projector machines or devices 108 (e.g. at least one projector machine or device per theater screen). For example, a projector machine P1 displays images on a first screen S1. Another projector machine Pn displays images on another screen Sn in the same cinema venue 106. The one or more projector machines 108, or the one or more server machines 107, or both exchange digital data with the festival management server system 110 or the computing device(s) 101 of the festival organizer, or both.

The server system 110 provides a web portal and facilitates email exchange between the other computing devices and servers.

In an example embodiment, a computing device 101 of a film festival organizer provides film information and filmmaker contact information (e.g. email address, telephone number, or some other digital communication address) to the server system 110 via a web portal (transmission 111). The web portal also receives other data, such digital film format restrictions, available transmission approaches, deadlines, etc. The server system 110 then generates and send emails to multiple filmmakers and their computing devices 103, 105 (transmission 112)

Using email and web portal access, the filmmaker's computing device sends over a data network the requested film data to the server system 110 (transmission 113), which is accessible by the computing devices 101 of the film festival organizer. Alternatively, a physical shipment of a computer readable medium is sent to the film festival organizer, and this action and status is digitally tracked by the server system 110 (computation 113′). In another example embodiment, the computer readable medium is shipped to an intermediary party that provides data formatting services or film festival organization services, or both, and the status of the film data in relation to the intermediary party is tracked by the server system 110.

The server system 110, for example, also verifies the digital film data and meta data (e.g. encryption key or keys) as part of the data transfer process. This verification includes, for example, coordinating with the server machines or projector machines at a cinema venue that will play the digital film (transmission 114 or 115, or both).

Through the web portal provided by the server system 110, and displayed on a computing device 101, a film festival organizer generates an electronic schedule that takes into account the technical specifications of the projectors, amongst other potential limitations.

The completed schedule and related data (e.g. the film data, encryption information, special instructions, etc.) may be electronically transmitted to the filmmakers, cinema venue(s), and to the computing devices of other relevant parties.

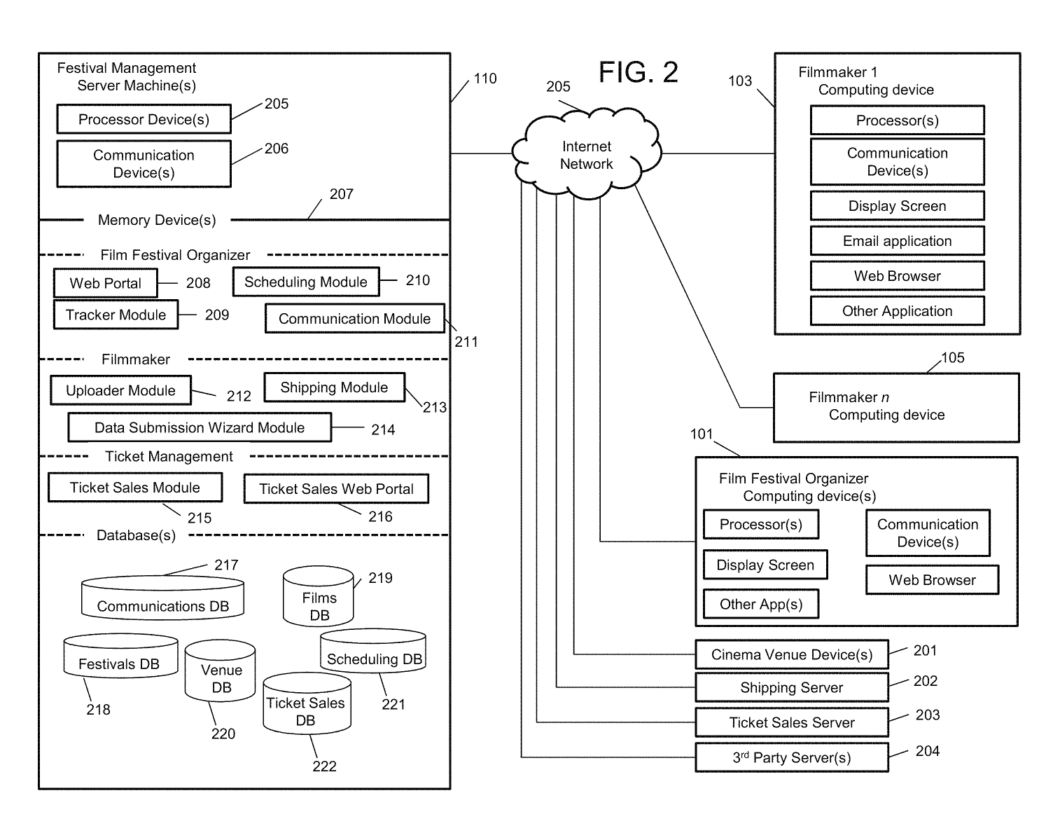

Turning to FIG. 2, the one or more festival management server machines, or server system, 110 is in data communication with an Internet network 205. Through the Internet, the server system 110 is able to be in digital communication with the computing devices 103 and 105 corresponding to different filmmakers, the one or more computing devices 101 of the festival organizer, the one or more devices or machines 201 associated with a cinema venue (e.g. servers and projector devices), a shipping server 202 (e.g. a computing server for FedEx or some other shipping service), a ticket sales server 203, and one or more 3^{rd} party servers 204.

The server system 110 includes one or more processor devices 205, one or more communication devices 206, and one or more memory devices 207. The memory stores thereon one or more modules including a web portal 208, a tracker module 209, a scheduling module 210, a communication module 211, an uploader module 212, and a shipping application programming interface (API) 213 used to track physical shipments from a shipping server 202. These modules provide information for the film festival organizer and can be viewed and interacted with via the web portal 208.

The tracker module 209 tracks the status and steps of obtaining the relevant data to screen or play the digital film data. The tracking and monitoring is, in many aspects, automatic and is displayable to an organizer via the web portal.

The scheduling module 210 includes rules and computations for generating an electronic schedule for displaying the films on different screens, and in potentially different cinemas. The scheduling module includes a GUI that allows a user to visually manipulate the schedule, while still applying the rules.

The communication module 211 automatically generates email addresses, each one to communicate information with a filmmaker related to a different film. The communication module also provides a GUI that links the communications to the status (e.g. the tracker module 209) and displays the communication directly within the web portal. This provides a unified GUI and software, which improves the effectiveness of the video data management.

The uploader module 212 facilitates obtaining the appropriate data format of a digital film, and the corresponding appropriate transfer approach of the digital film. The shipping API 213 may be part of the uploader module to facilitate physical shipping and tracking of physical packages. The uploader module 212, for example, also performs data verification and encryption verification in coordination with the designated projector machines that the film is assigned to be played upon.

A data submission wizard module 214 is also provided to facilitate the filmmaker to provide data related to their film submission, and to facilitate the transfer of the digital film data to the film festival organizer via the server system 110. The wizard module is launched via a link embedded in an email sent to a filmmaker.

The server system 110 also includes a ticket sales module 215 that tracks ticket sales for a given film. This information may be used by other modules to automatically or semi-automatically adjust the scheduling of a film, or the assignment of a film to a given theater (e.g. to match seating capacity of a given theater with expected the number of people watching the film). The ticket sales module may interact with a third party ticket sales server 203, which sells tickets for the film festival.

In another aspect, the server system 110 includes its own ticket sales web portal 216 that manages the sales of tickets to film festival attendees or other ticket distributors.

It will be appreciated that the functionalities of the modules may be combined in different ways. Furthermore, the modules may coordinate computations with each other.

The memory also includes a number of databases for storing the data in an organized manner. An example of databases includes a communications database 217, a festivals database 218, a films database 219, a venue database 220, a scheduling database 221, and a ticket sales database 222. The organization of the data amongst databases may differ from what is shown.

The computing device of filmmaker and the computing device of a festival organizer each include a processor, a communication device, a display screen, a web browser, and other applications (e.g. an email application, an application specific to the film festival management, etc.). In general, the display of the web portal or the data submission wizard on these computing devices occurs via a web browser.

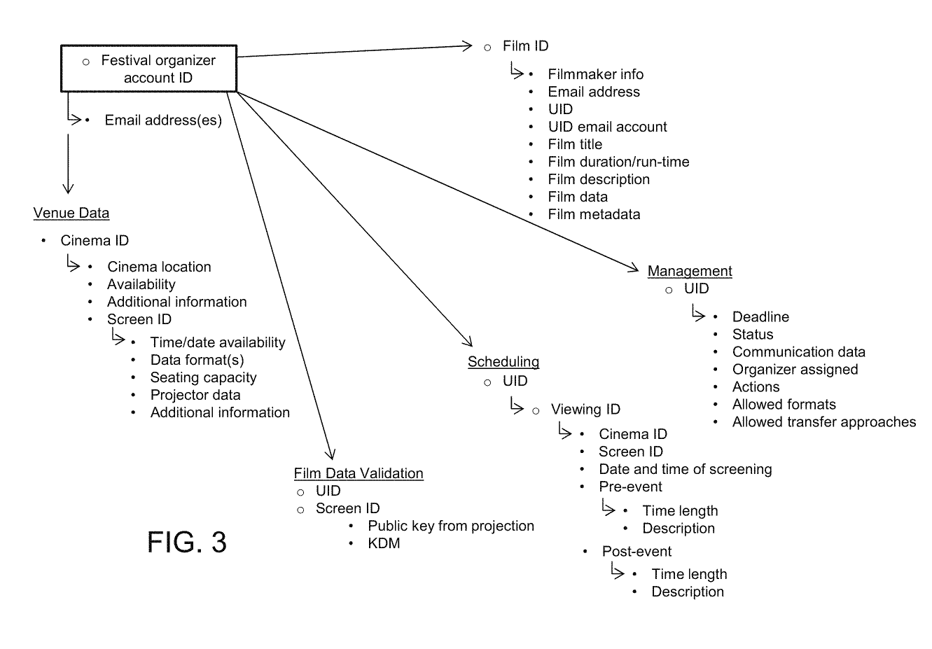

Turning to FIG. 3, example data that is stored in the server system 110 is shown. A film festival organizer has their own account ID, which may be associated with one or more email addresses. The organizer account ID is associated with multiple film IDs, each film ID representing a different film.

A festival organizer account ID is also associated with one or more cinema IDs, each cinema ID related to different cinema data and to one or more screen IDs, each screen ID identifying a theater screen within a cinema. It will be appreciated that a cinema may have multiple theater screens.

The film ID is associated with filmmaker information (e.g. name), the filmmaker's email address, a unique ID also called a UID, a UID email account, and information about the film (e.g. title, duration/run-time, description, the film data itself, film metadata, etc.).

In an example embodiment, the run-time of a film is provided by a filmmaker via the submission wizard. In another example embodiment, the server system 110 automatically computes a run-time of a film by obtaining the total number of frames and the frame rate (e.g. frames per second) from the film metadata, and the dividing the total number of frames by the frame rate.

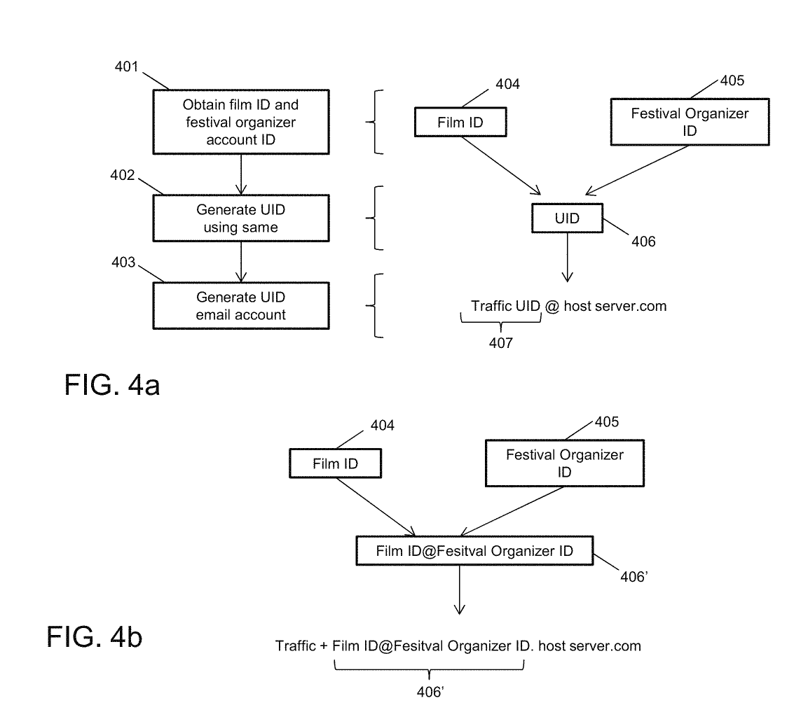

Turning briefly to FIG. 4a, the server system 110 automatically generates a UID and a UID email account. At block 401, the server system obtains the film ID and the festival organizer account ID from memory. At block 402, the server system generates the UID using the film ID and festival organizer ID. In another example, the UID is a unique alphanumeric value that corresponds to a combination of a film ID and the festival organizer ID. It will be appreciated that the festival organizer ID is used or accounted by the server system 110, since the server system is able to organize multiple film festivals and a certain film may be screened at multiple film festivals.

At block 403, the server system generates an email account for the festival organizer and this is used only to communicate with the filmmaker associated with the film ID.

In particular, the film ID 404 and festival organizer ID 405 are used to generate a UID 406, or are assigned to the UID 406. The server system generates an email address 407 that comprises the UID 406. For example, the automatically generated email address is a concatenation of “traffic”, the UID 406, the @ symbol, and the host server name or domain name. More generally, the local-part 407 of the email address comprises the UID 406.

In another example, in FIG. 4b, the UID 406′ is formed from concatenating the film ID, the ‘@’ symbol, and the festival organizer ID. An email address is then formed by concatenating at least the UID 406′ with “.” and the host server (e.g. film ID@festival organizer ID.hostserver.com). Alternatively, the email address is preceded with a term, such as “traffic” or “print traffic” (e.g. traffic+film ID@festivalorganizerID.hostserver.com).

In this way, email communications between a particular festival organizer and a filmmaker about a particular film may be digitally isolated from other communications of different festivals and films. This improves the efficiency and effectiveness of managing and scheduling the digital film data for a festival.

Returning to FIG. 3, the management of the film data includes associating different data with the UID, including a deadline to submit a film, a status of the management process, communication data, allowed data formats, allowed transfer approaches, etc. The allowed data formats depend on the projector specifications.

The scheduling of the film data includes associating different data with the UID, including a viewing ID and cinema ID. It is appreciated that a viewing ID is used to identify a specific screening or playing at a festival, since a film may be screen or played multiple times at a festival (e.g. on different screens, on different dates, on different times, etc.). Pre-event and post-event data may be stored in association with the viewing ID.

For executing computer processes for film data validation, the server system 110 also stores public key data from one or more projectors and KDMs in relation to the respective UIDs and screen IDs.

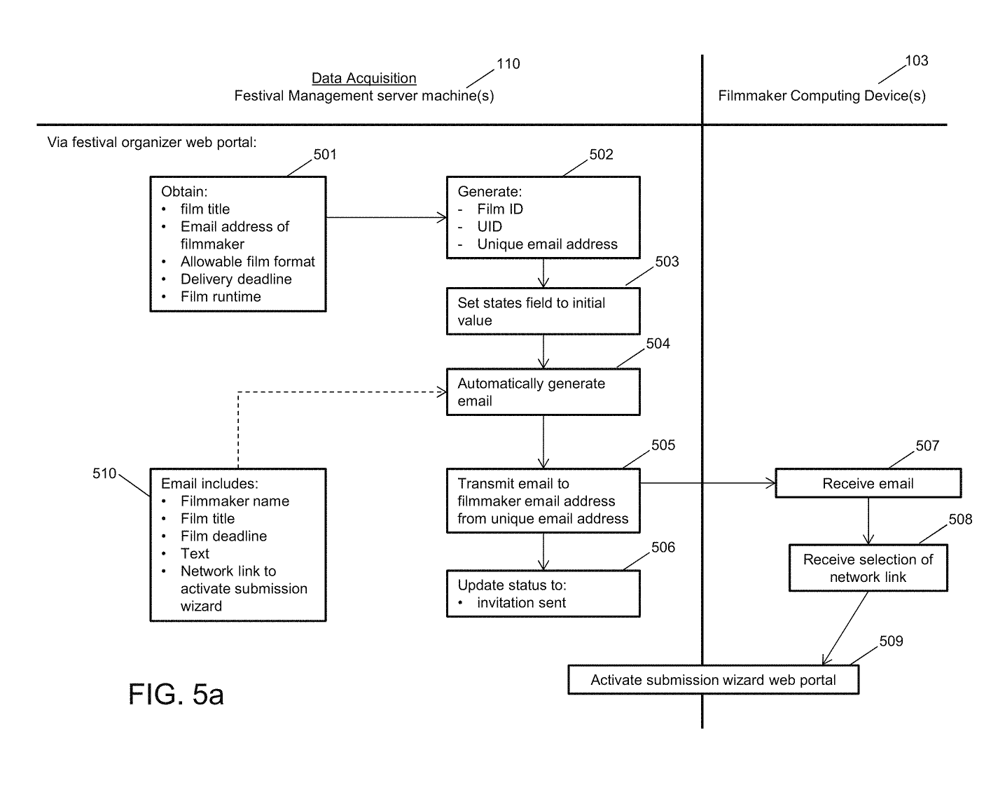

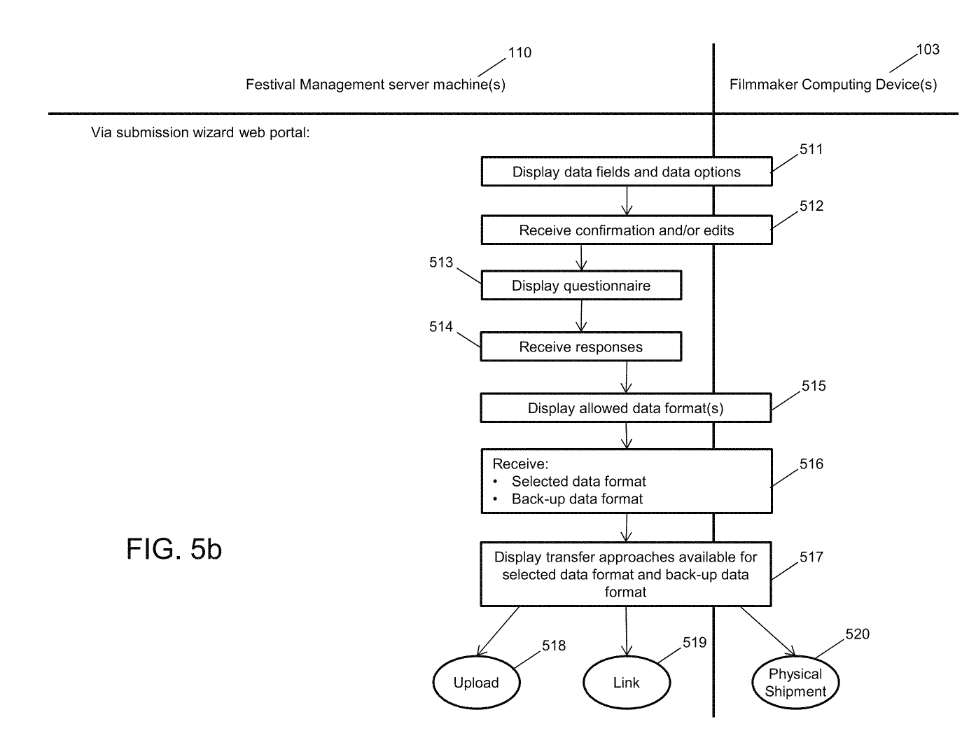

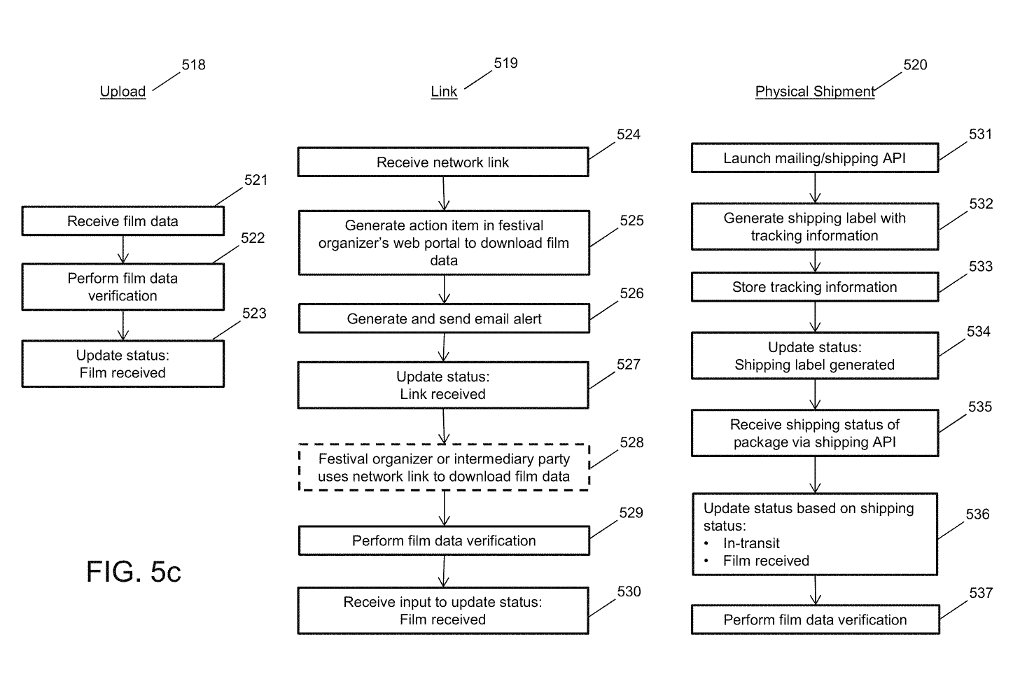

Turning to FIGS. 5a, 5b and 5c, example executable instructions are executed by the server system 110 to acquire the digital film data from a filmmaker.

At block 501, the server system 110 provides a web portal that is accessible by a computing device 101 of a film festival organizer 100. Through the web portal, the server system obtains the film title, the email address of the filmmaker (or some other electronic contact address information), allowable film formats, allowable delivery methods (e.g. internet upload, physical media, etc.) the delivery deadline (e.g. the deadline that the filmmaker must submit the film data), and a film runtime. In an example embodiment, allowable film formats are automatically determined by the server system based on the cinema or cinemas specified by the film festival organizer for hosting the film festival. For example, a projector device or machine at the reserved cinema will only play certain data formats of film data.

At block 502, the server system 110 automatically generates a corresponding film ID, a corresponding UID and a corresponding unique email address. This was described with respect to FIG. 4.

The server system also sets the status field to an initial value (block 503).

At block 504, the server system automatically generates an email. In particular, the server system accesses the databases and compiles an email that includes the filmmaker's name, the film title, the deadline, custom or template text regarding the festival, and a network link that, when selected, activates the film data submission wizard (block 510).

At block 505, the server system transmits the email to the email address using the unique email address. In other words, when the filmmaker's computing device 103 receives the email (block 507), it will be sent from the unique email address (e.g. trafficUID©hostserver.com). The filmmaker, after opening the email, then selects the embedded network link (block 508), which activates the film data submission wizard (block 509). It will be appreciated that the wizard is provided by the server system 110 and is viewable from the display screen of the computing device 103. The film data submission wizard includes a GUI aspect provided by the data submission wizard module 214.

After the email is sent, the server system automatically updates the status to “invitation sent” (block 506).

Continuing with FIG. 5b, at block 511, the submission wizard displays data fields and data option 511 via the filmmaker's computing device 103. The wizard receives user input from the computing device 103 confirming the displayed information, or to edit the information, or both (block 512). At blocks 513 and 514, a questionnaire for the filmmaker may be displayed and answers to the same may be received via the wizard. At block 515, the wizard displays the allowed data formats for the digital film submission. Non-limiting examples of data formats include DCP, QuickTime File, DVD, BluRay, 35 mm Film . . . etc. At block 516, the server system receives an input from computing device 103 to select a data format for the film data submission, and may optionally receive an input that selects a data format for a back-up or ancillary submission of the same film.

At block 517, based on the selected data format and the selected back-up data format, the server system determines what are the available transfer approaches for the data format (or data formats) and displays the same for selection (block 517). It is appreciated that some types of data formats can only be transferred in certain ways. Examples of options for the film data transfer include uploading 518, sending a network link 519 for the film organizer to access and download the data, and physical shipping 520 of a computer readable medium.

Turning to FIG. 5c, if the uploading option 518 is selected, then the server system receives the film data from the filmmaker's computing device 103 (block 521). The server system may also perform film data verification (block 522). If the data is verified without error, then the server system updates the status of the process of to indicate that the film data has been received (block 523).

If the network link 519 is selected, then the server system receives the network link (block 524). For example, the filmmaker inputs the network link via the wizard GUI. At block 525, the server systems generate an action item in the festival organizer's web portal to download the film data using the network link. An email alert regarding the same is automatically generated and sent to the film festival organizer's email account (block 526). The server system automatically updates the status to indicate that a network link has been received (block 527).

A festival organizer, via their computer device 101, access the web portal on the server system to select the network link and to download the film data (block 528). At block 529, the server system performs film data verification. At block 530, after the data is verified, the server system updates the status to indicate that the film has been received.

If the physical shipment option 520 is selected, then the server system launches the mailing or shipping API (block 531) that interacts with a computing server 202 of a shipping company (e.g. FedEx or some other shipping service). Based on user input through the submission wizard GUI and the shipping API, the server system generates a shipping label with tracking information (block 532) that the filmmaker can print out. The server system stores the tracking information (block 533) and automatically updates the status, which is viewable by a film festival organizer in a web portal, to indicate that shipping label has been generated (block 534).

At block 535, the server system receives one or more shipping status updates about the shipped package containing the computer readable medium that stores the film data. These shipping status updates are obtained via the API.

At block 536, the server system updates the status of the process, which is viewable via the web portal, based on the obtained shipping status. For example, the status may indicate that the shipment is in-transit, or that the shipment of the computer readable medium has been received.

At block 537, the server system performs video data verification.

It will be appreciated that if film data verification is not successful at blocks 522, 529 or 537, then a message alert is generated to alert the user of the same. The process may then restart at one of blocks 518, 519, 520, or at block 517.

In an example embodiment, there is an intermediary party that acts on behalf of the film festival organizer to collect the films and to perform film data verification. For example, when an intermediary party is involved, the flow of the status updates include: Invitation Sent>Details Confirmed>In Transit (e.g. contextual and automatically updated)>Received at Intermediary Party>Received at Festival. In other words, the intermediary party obtains the film data and verifies the same using the server system. After verifying the film data and conducting other services, the film data is sent (e.g. over an electronic data network or as a physical shipment) to the festival organizer or directly to the film venue for screening. In an example embodiment, the other services conducted by the intermediary party include reformatting the film data,

In another example embodiment, an intermediary party is not involved and the status information generated by the server system includes: Invitation Sent>Details Confirmed>In Transit (e.g. contextual and automatically updated)>Received.

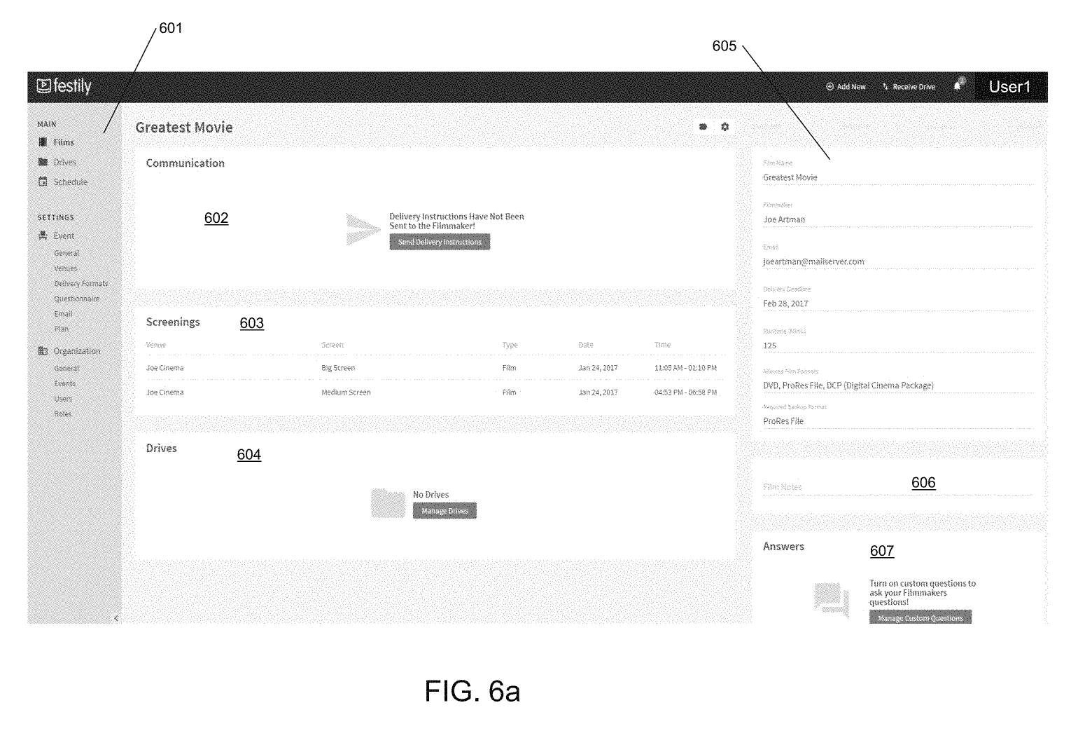

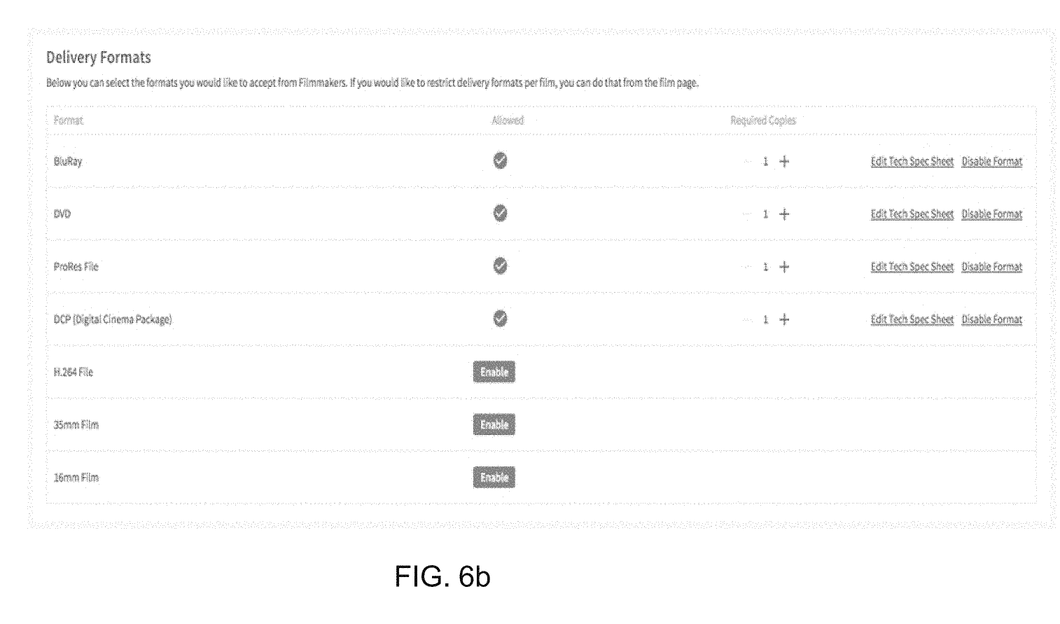

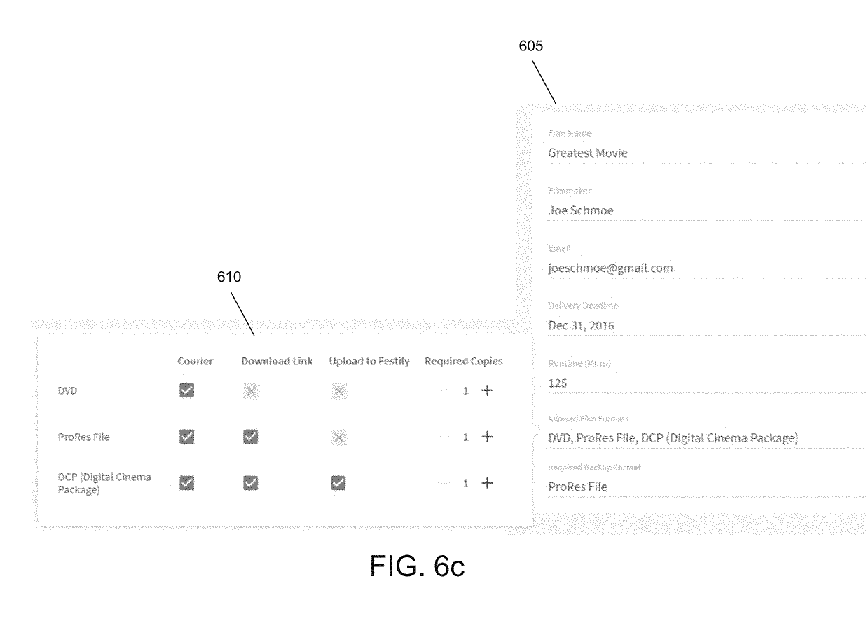

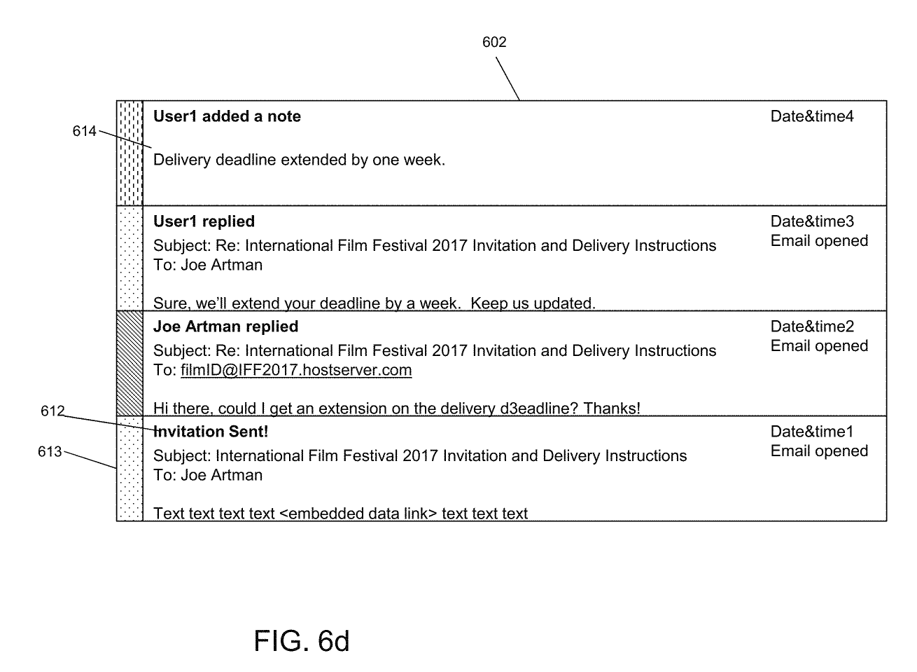

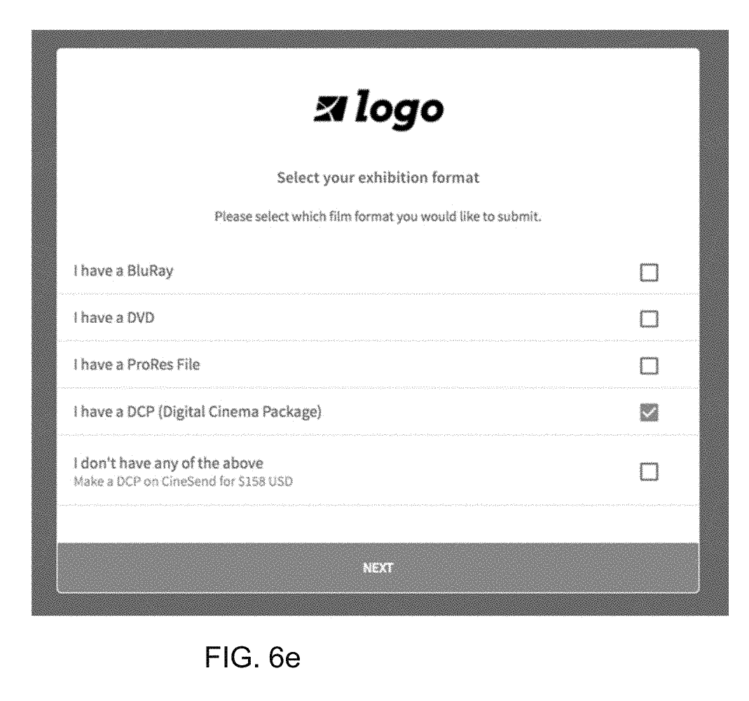

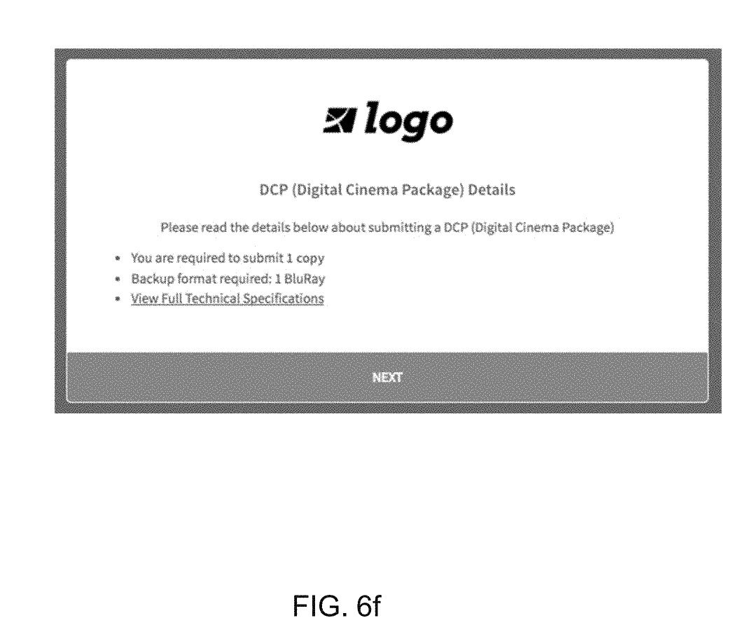

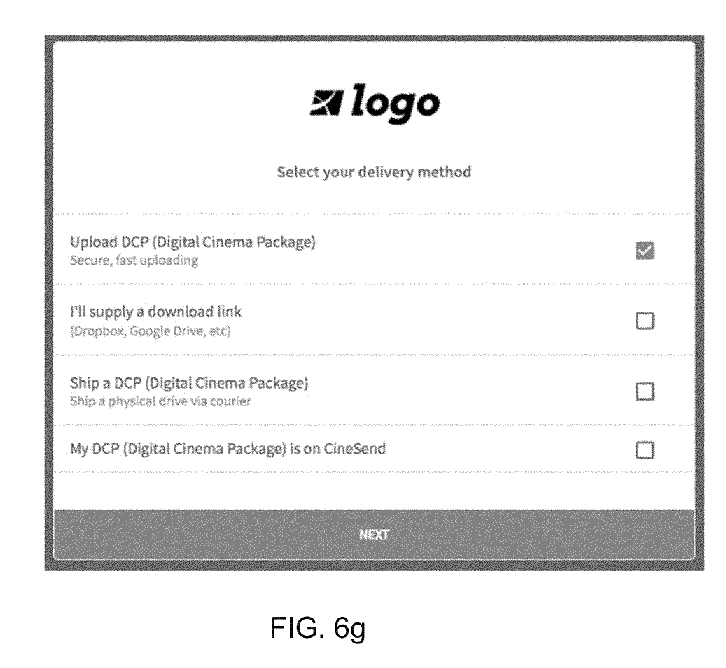

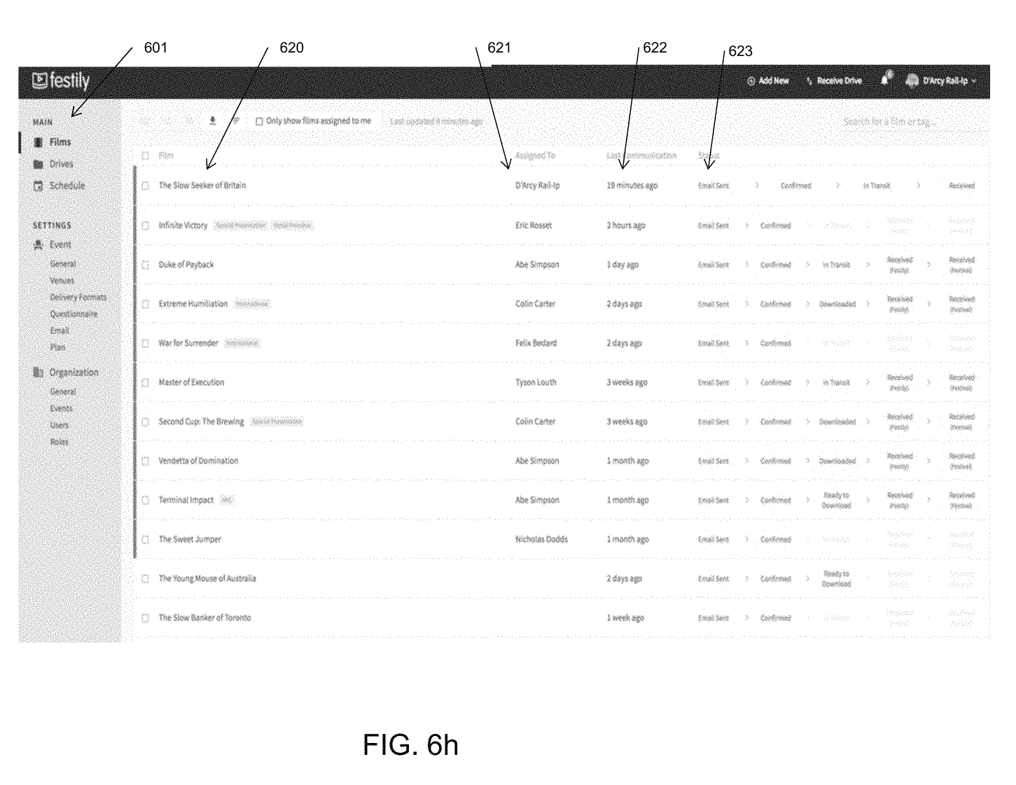

Turning to FIGS. 6a to 6h show various graphical user interfaces (GUIs) for obtaining film data and tracking the status of the same.

FIG. 6a shows a web portal GUI that is displayed by a festival organizer who is compiling information to send an invitation to a filmmaker to screen or play the film at the festival. The GUI includes a menu 601 that has controls to display films, drives, a schedule, settings (e.g. setting related to event, general, venue, delivery formats, questionnaire, email, organization, users, rules, etc.). A communications panel 602 displays email exchanges within the GUI, alongside other important information related to the screening of the film. A screenings panel 603 shows information about where and when the subject film is to be played (e.g. venue, screen, type, date and time). Panel 604 shows information about the physical drives (e.g. computer readable mediums that store the film data), including location and identification information. Panel 605 shows general information about the film, and this information is editable by the film festival organizer. For example, the information includes the film name, the filmmaker name, the filmmaker's email, the deadline delivery, allowed formats, backup format, etc. There is also a field 606 for additional notes. There is also a panel 607 that allows the film festival organizer to enter custom questions and to view the answers from the filmmaker.

FIG. 6b shows a GUI that is part of web portal GUI show a listing of data formats for films, whether or not the formats are allowed at the festival, and the required number of copies. In an example embodiment, the determination of the allowed formats is automatically determined based on the screen or projector specification of the cinema venue. In another example, a user selects or modifies which of the formats are allowed or not. A similar GUI is made available for selecting a backup format, if the festival organizer wishes to create such a requirement.

FIG. 6c shows an part of an example embodiment of the GUI shown in FIG. 6a. In particular, when a format field in the panel 605 is selected, a detailed format GUI 610 is displayed. It shows a selection matrix with the allowed data formats in a side column and the delivery methods. For example, a filmmaker can transfer a DVD via courier, but not through a download or an upload link. A ProRes file can be transferred through courier and a download, but not through an upload link. The delivery or transfer approach for a given film can be modified using the GUI 610.

FIG. 6d shows an example of a communication panel 602 in isolation and having sent and received email messages. Each message may show a summary text 612 that is automatically generated by the server system 110 (e.g. Invitation Sent!, Joe Artman replied, User1 replied, User1 added a note, etc.). A color or other visual indicator 613 shows who sent the message (e.g. the filmmaker or the film festival organizer). Other information, such as notes to the system added by the film festival organizer, can be included in the panel 602.

FIG. 6e shows a GUI displayed to a filmmaker as part of a wizard to transfer film data. It lists film formats that are allowed by the film festival.

FIG. 6f shows details in the wizard GUI about transferring a film in a selected data format (e.g. DCP).

FIG. 6g shows a subsequent GUI in the wizard that allows a filmmaker to select a delivery or transfer method for the film data.

FIG. 6h shows a GUI that is part of the web portal, which can be viewed by a film festival organizer. It shows a list of films 620, the corresponding individuals of the film festival organization that are assigned to handle the film, the length of time between the present time and the last communication, and the status (e.g. invitation sent, confirmed, in transit, ready to download, downloaded, received, etc.).

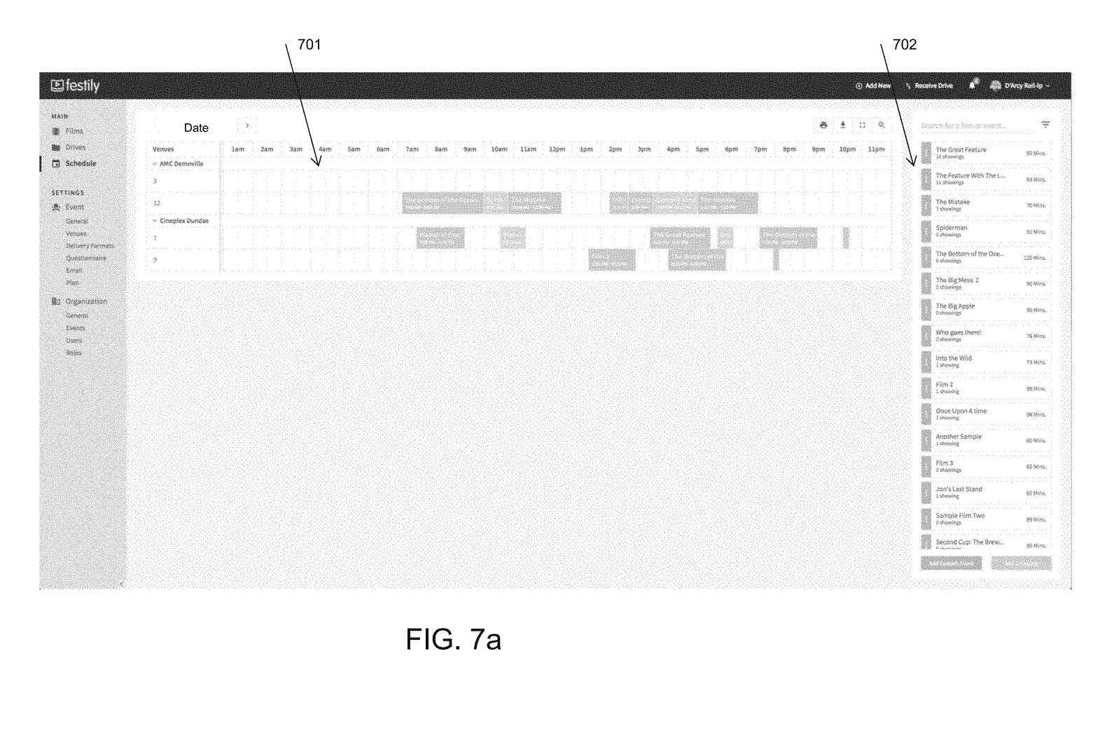

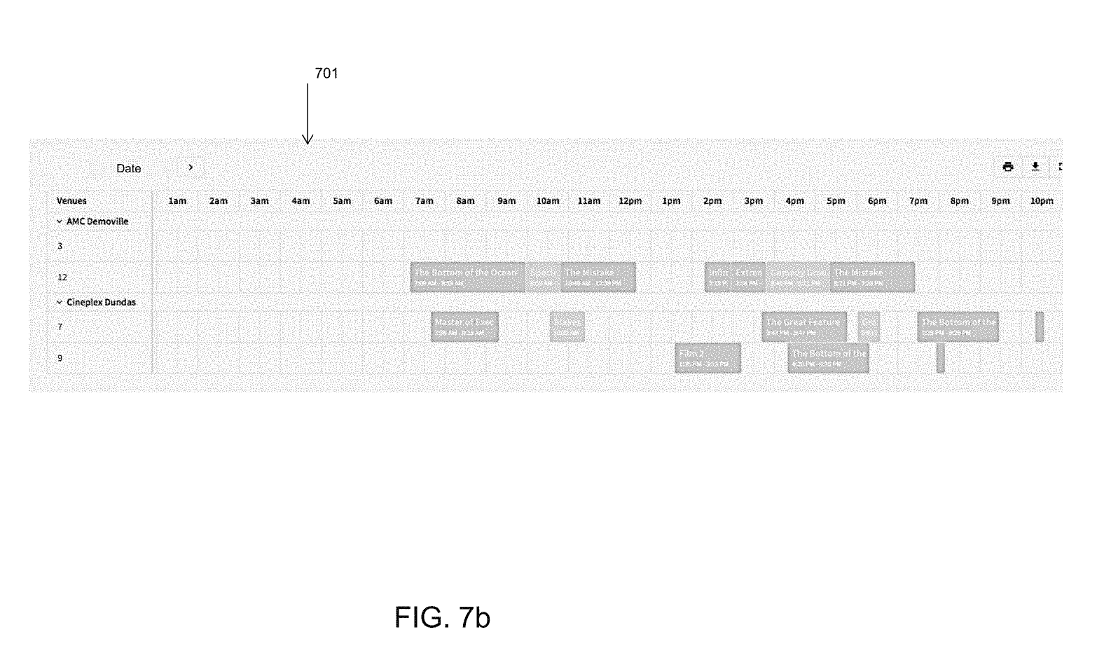

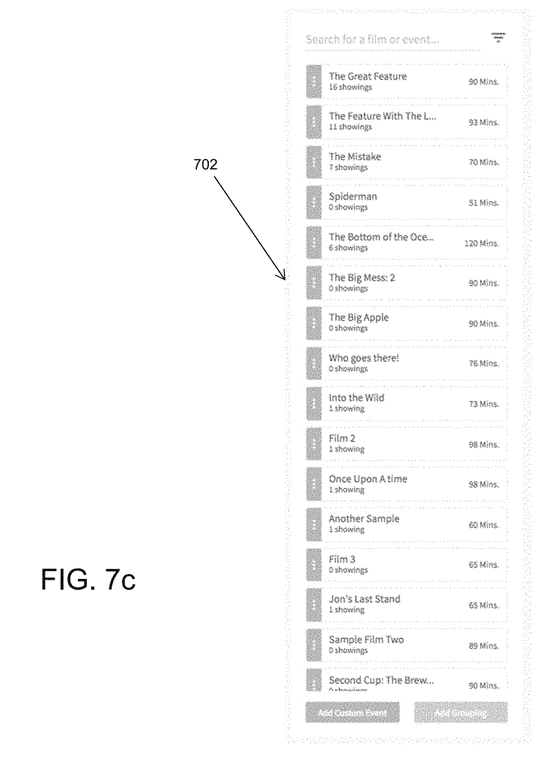

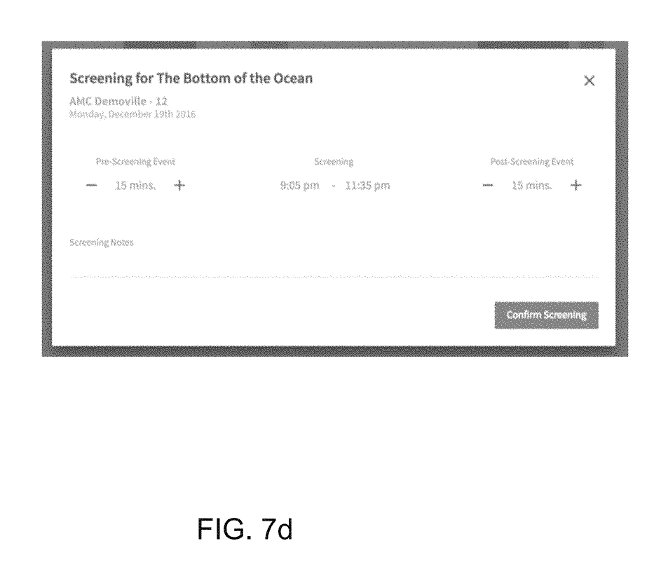

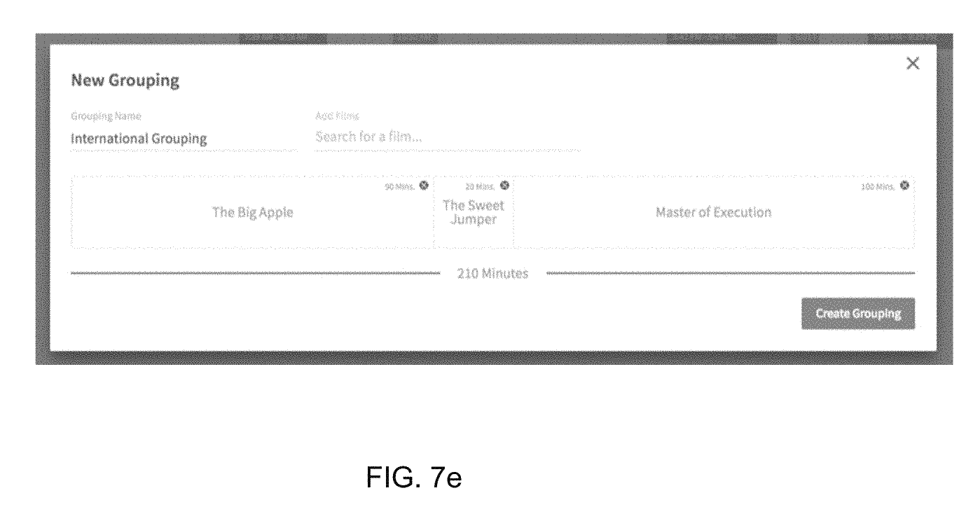

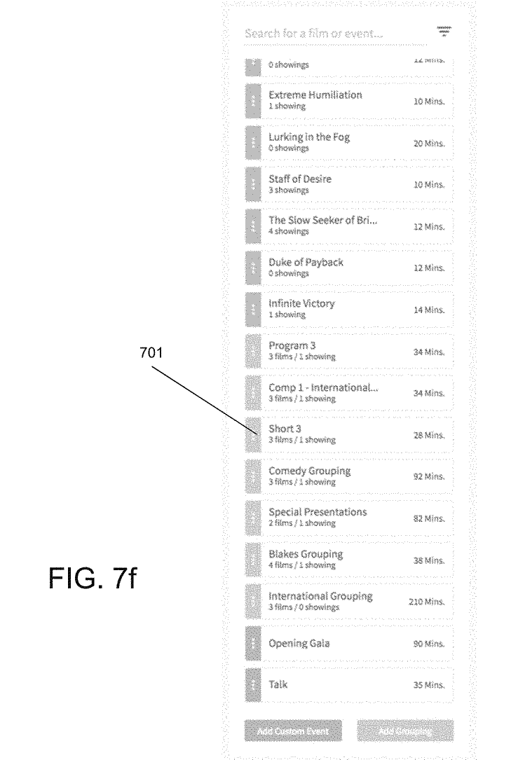

FIGS. 7a-7f show different GUIs used to schedule films in an electronic calendar.

FIG. 7a shows a scheduling GUI in the web portal, which can be viewed by a film festival organizer. It includes an electronic calendar 701 showing the cinema venues and the screens within each venue, as well as the time slots. A list 702 of films to be shown at the film festival are also shown, and a film entry or a group of films from the list 702 can be dragged and dropped into a particular time slot for a given screen.

FIG. 7b shows the electronic calendar 701 in isolation.

FIG. 7c shows the list 702 in isolation. As can be better seen in FIG. 7c, each film entry on the list includes the time length and the number of showings or screenings over the course of the festival.

FIG. 7d is another GUI that is used to add a pre-event or a post-event relative, or both, to a given screening of a film.

FIG. 7e is another GUI that is used to form a grouping of films.

As shown in FIG. 7f, a grouping entry 701 is a single collection of films that can be dragged and dropped into the electronic calendar. The grouping entry 701 shows that there are 3 films, and that the grouping is to be shown or screened once.

Either before or after the film data is obtained, the film organizer can use the web portal to begin generating an electronic schedule of the films to be played or screened at the film festival.

As the actual film data is acquired by the server system, the actual length or runtime of the film may change from what was initially inputted by the film festival organizer. The updated runtime of the film is automatically reflected or updated in the scheduling, should the film already be placed in a schedule.

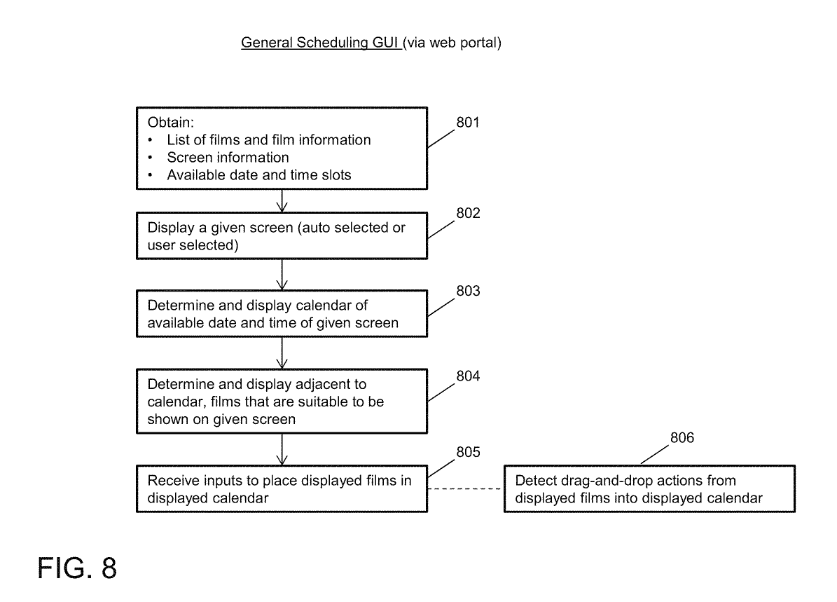

Turning to FIG. 8, an example of computer executable instructions is provided that are executed by the server system for a scheduling GUI in the web portal.

At block 801, the server system 110 obtains a list of films and film information for the film festival, the screen information (e.g. screen ID, projector ID, available film data formats, seating capacity of the corresponding theater screen, etc.), and available date and time slots that the one or more theater screens can be used for the festival. This information, for example, is obtained by accessing one or more databases in the server system 110.

At block 802, the server system generates, within a scheduling GUI, a given screen. The screen may be automatically selected or user selected.

At block 803, the server system determines and generates a calendar showing the available date and time slots of the given screen within the same scheduling GUI.

At block 804, the server system determines and generates within the scheduling GUI, next to the calendar, one or more films that are suitable to be shown on the given screen. Each film that is displayed is shown as a separate data entry (e.g. having a visual border) that can be visually manipulated, such as by dragging and dropping the data entry of a specific movie into the calendar. Other types of input may be used to link the data of time slot to a film for the purpose generating an electronic schedule.

The server system 110 uses one or more rules to automatically determine which films are viable for showing on the given screen. For example, if the given screen has a projector that can only show films in the DCP format, then the server system only shows the one or more films in the DCP format next to the calendar.

In another example, if a film is to be screened or played n number of times (e.g. where n is an integer number 1 or higher), then the films displayed next to the calendar may also reflect whether or not the films have already been scheduled. For example, a film called “Winning Short” is limited to be played one time, and it has already been scheduled to play on Day 2 of the film festival on Screen X. Therefore, if Screen Y is being shown in the scheduling GUI, whether for Day 2 or some other day of the festival, then server system does not display a data entry for the film “Winning Short” next to the Screen Y, since it has already been scheduled to play on another screen.

In another example, the server system 110 has a rating system of films, a rating system of date and time slots, and a rating system of screens. The one or more rating systems may be used to generate a sequenced list of films that can be shown on a given screen. The sequence of the films reflects a suggested priority to schedule the one or more films. For example, if the given screen is associated with a large seating capacity theater screen, then highest rated films are listed at the top of the scheduling GUI in association with the calendar availability for the given screen. Conversely, the lowest rated films are listed at the bottom of available film list in the scheduling GUI in association with the calendar availability of the given screen.

In another example, if a highly rated date and time slot of a given screen is being displayed in the calendar of the scheduling GUI (e.g. 7 pm-12 pm on a Friday), then the server system will automatically determine and display the highest rated films listed at the top of the scheduling GUI in association with the calendar availability for the given screen. In this way, the festival organizer is influenced to select the highest rated film for scheduling at a prime date and time slot.

It will be appreciated that the above rating systems may compute or obtain the ratings in various approaches. It will also be appreciated that one or more of the above rating systems may be used to suggest scheduling of films, or to semi-automatically generate a schedule of films.

At block 805, through the scheduling GUI, the server system receives inputs to place the displayed film or films in the displayed calendar. For example, this may be through detecting drag-and-drop actions by dragging a displayed film into a time slot in the displayed calendar (block 806). However, other types of GUI mechanisms may be used to assign a given film to a given time slot in an electronic calendar.

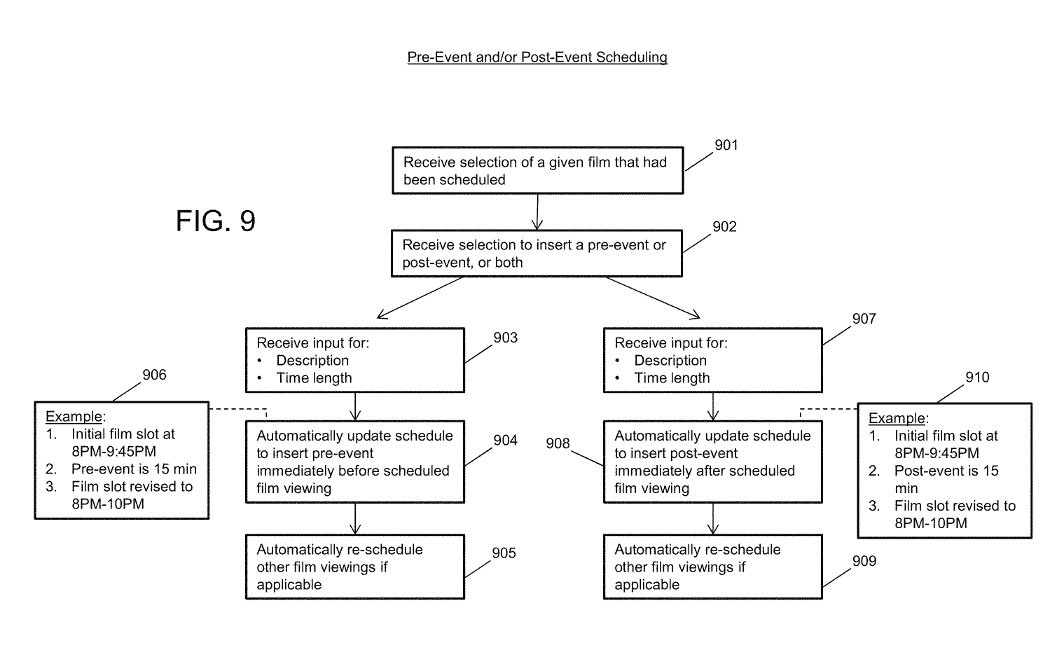

Turning to FIG. 9, computer executable instructions are provided for a server system 110 to insert a pre-event or a post-event, or both, relative to a film to be played or screened at the festival. If the film has not been scheduled, a pre-event or a post event, or both, can be added, and the pre-event or post-event will be automatically scheduled with the film when it is scheduled. If the film has already been scheduled, the schedule will be automatically updated to accommodate the pre-event or post-event, or both.

A pre-event is an event that is scheduled immediately prior to the screening of a film. For example, the filmmaker is given an opportunity to introduce the film in period of 10 minutes in the pre-event. The post-event is an event that is scheduled immediately after the screening of the film. For example, during a post-event, there may be a question and answer session from the audience and the actors and directors of the film.

In an example embodiment, at block 901, the server system 110 receives a user input selection of a given film that has already been scheduled. At block 902, the server system also receives a selection to insert a pre-event or a post-event, or both, relative to the selected given film.

With respect to a pre-event, at block 903, the server system receives an input to specify a description of the pre-event and a length of time of the pre-event. At block 904, the server system automatically updates the schedule to insert the pre-event in the electronic calendar before the scheduled film viewing. At block 905, the server system automatically reschedules other film viewings or screening if applicable (e.g. postponing other film screenings due to the pre-event).

It will be appreciated that the pre-event and the film entry in the electronic calendar are linked together, and moving the film entry in the electronic calendar to another day or time also automatically includes moving the pre-event.

As an example of automatically updating the schedule (block 906), a film is initially slotted or scheduled to be screened from 8 pm-9:45 pm. A pre-event of 15 minutes is added to the screening or viewing. Therefore, the film's time slot is reschedule to cover the time period from 8 pm to 10 pm. A similar example applies for post-events, as per block 910.

Similar computations are automatically performed when scheduling a post-event. The server system receives an input for a description and time length of the post-event (block 907), and then automatically updates the schedule to insert the post-event in the electronic calendar, immediately after the scheduled film screening or viewing (bock 908). At block 909, the server system automatically reschedules other film screenings or viewings if applicable.

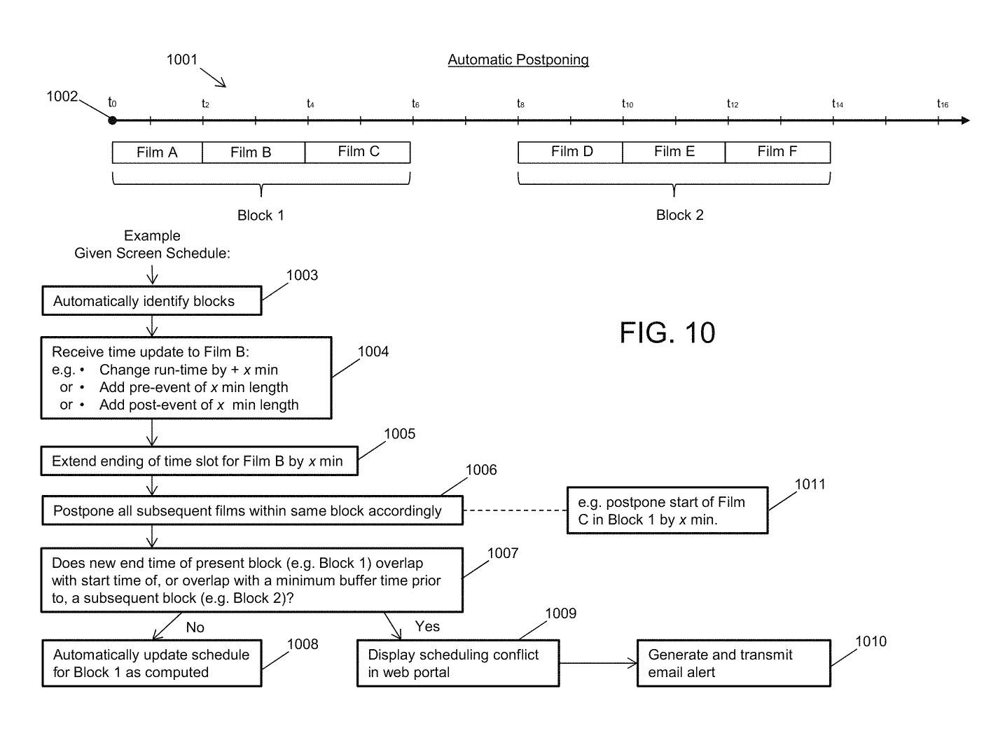

Turning to FIG. 10, example computer executable instructions are provided for automatically making postponements of scheduled film screenings in an electronic calendar.

An example screen schedule 1001 for a given screen is shown, which includes a number of time slots 1002. For example, Film A, Film B and Film C are scheduled to be shown consecutively from the time slots t₀ to t₅. Each time slot, for example represents one hour or some other time unit.

Film D, Film E and Film F are scheduled to be shown later that same day, starting at t₈. In other words, there is a buffer of time between the end of Film C and the beginning of Film D. Film C and Film D are therefore not consecutively shown.

At block 1003, the server system automatically identifies the blocks of films in a schedule. A ‘block’ herein refers to a consecutive screening of films on the same screen. In the example of FIG. 10, the server system determines that Films A to C from Block 1 and that Films D to F form Block 2.

At block 1004, the server system receives a time update to Film B. For example, the runtime of Film B is increased by x minutes. In another example, a pre-event that is x minutes long is added to the screening of Film B. In another example, a post-event that is x minutes long is added to the screening of Film B.

At block 1005, the server system extends the ending of the time slot for Film B by x minutes. In an example embodiment, as a rule, the server system prioritizes extending an end time compared to moving forward a start time of a film.

At block 1006, the server system postpones all subsequent films within the same block accordingly. In the given example, the server system therefore postpones the start time of Film C, which is Block 1, by x minutes.

At block 1007, the server system determines if the new end time of the present block (e.g. Block 1) overlap with a start time of, or overlap with a minimum buffer time prior to, a subsequent block (e.g. Block 2)? For example, if there is no minimum buffer time, the testing determines the end time of Block 1 overlaps with the start time of Block 2. If there is a minimum buffer time (e.g. one time unit), the testing determines if the end time of Block 1 overlaps with the start of the minimum buffer time (e.g. t₇ when the buffer time is one unit).

If there is no overlap, then the server system automatically updates the schedule to Block 1 as computed (block 1008).

If there is overlap, then the server system does not automatically update the schedule based on the computation. Instead, the server system displays a scheduling conflict within the web portal based on the received time update (block 1009). The server system also generates and transmits an email alert regarding the same (block 1010) to notify the festival organizer. In this way, the festival organizer can decide how to rectify the schedule.

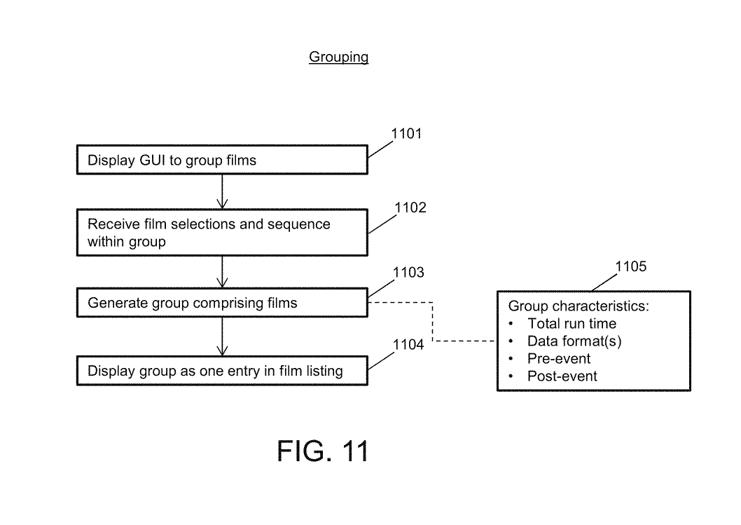

Turning to FIG. 11, example computer executable instructions are provided for grouping films together within the scheduling GUI. For example, multiple film shorts can be grouped together and the group can be scheduled and manipulated as one data item in the electronic calendar.

At block 1101, the server system 110 display a GUI with controls to group multiple films together. At block 1102, the server system receives the film selections and a sequence for the films with the group. At block 1103, the server system generates a data structure that defines the group, which includes the selected films. The group characteristics are part of the data structure and include, for example, the total runtime of the entire group and one or more data formats (block 1105). There may be multiple data formats for one group if there are at least two films in the group with different data formats.

At block 1104, the server system displays the group as an entry in the film listing, next to a calendar in the scheduling GUI. The group may be dragged and dropped into an available slot in the electronic calendar displayed in the scheduling GUI.

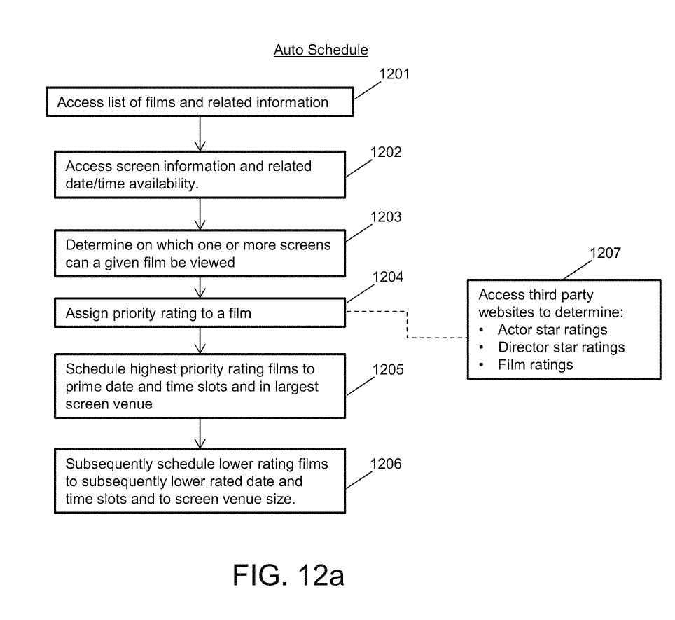

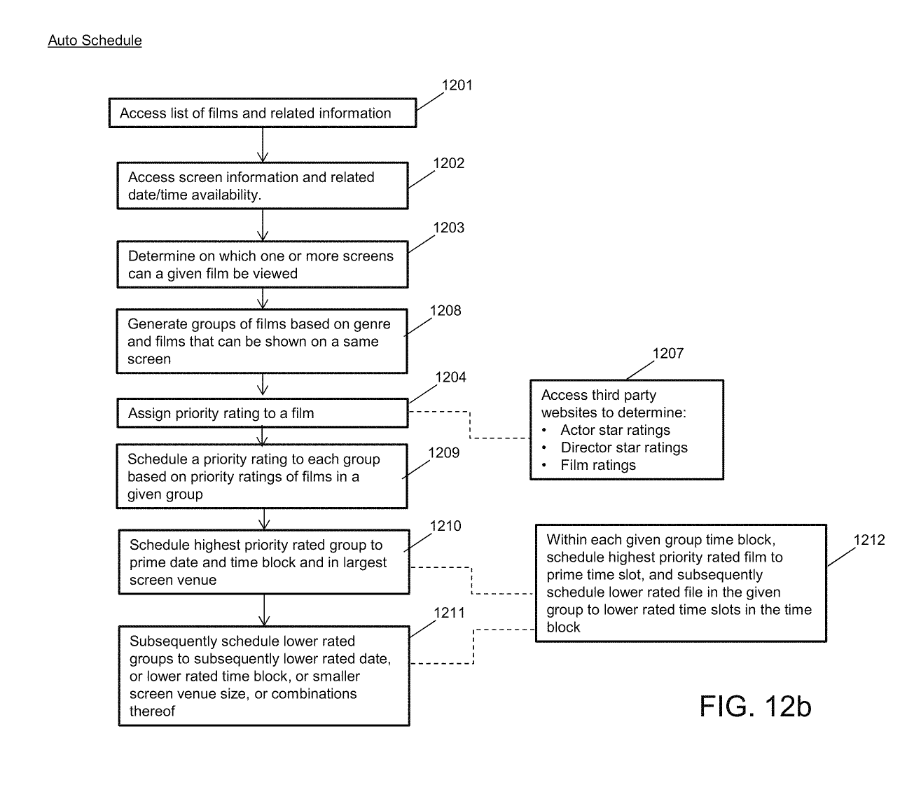

FIG. 12a shows example computer executable instructions for the server system to automatically schedule films. It will be appreciated that some films of the total number of films may be automatically scheduled, and some other films may be manually scheduled.

For example, a film festival organizer may manually schedule the most important or popular films in the electronic calendar (e.g. using drag and drop actions), and then select a control to initiate the server system to automatically schedule the remaining films that have not yet been scheduled. This may be helpful where there are, for example, hundreds of films to be screened or played across many different theater screens and over many days.

In another example, the server system 110 automatically generates a schedule using all the films to be screened or played, and then the film festival organizer makes changes or modifications. This approach may also be helpful where there are, for example, hundreds of films to be screened or played across many different theater screens and over many days.

At block 1201, the server system 110 accesses a list of films to be scheduled for the film festival and the related film information (e.g. runtime, data format, viewing format, etc.).

At block 1202, the server system accesses the screen information (e.g. accepted data format and viewing format, seating capacity, etc.) and the related date and time availability. At block 1203, the server system determines with which one or more screens that a given film can be screened using the compatibility rules, for example, related to data format and viewing format.

At block 1204, the server system assigns a rating to a film, which affects its priority in the automatic scheduling process. For example, the server systems access third party website servers to determine the actor start rating, the director star rating and the film's rating, if these rating are available. For example, the electronic text of a director name and electronic text of the actor names may be part of the film's related information, and the server system obtains this information to execute a query on one or more information websites using the names. For example, a rating on the website IMDB or some other website is used to determine the popularity of an actor or a director, or both. A highly rated actor (e.g. a popular actor) will lead to a high rating of the film to be screened at the festival. This data may be used in conjunction with rating data input by festival organizers manually, or imported from another source. It will be appreciated that there may different computations and data relationships to identify a rating value for the film to be screened at the festival.

At block 1205, the server system schedules the highest rated films to the prime date and time slots in the theater screen venue with the largest seating capacity, or with the largest sized screen, or both. Subsequently, the server system schedules the lower rated films to subsequently lower rated date and time slots or to smaller screen venues, or both (block 1206).

In an example embodiment, machine learning or artificial intelligence techniques may be applied to the above principles to automatically schedule films for a film festival.

In another example embodiment as shown in FIG. 12b, groups of films are formed and are automatically scheduled together. For example, a group of films can be formed according to a film genre or some other attribute. Examples of other attributes used to form groups include location or setting of the film, culture associated with the film, language of the film, and a motion picture rating (e.g. rated G for general audience, PG for parental guidance, R for restricted, etc.).

In FIG. 12b, at block 1201, the server system 110 accesses the list of films and the related information. The related information can include the genre tag or other attribute tag. Blocks 1202 and 1203 are executed. Subsequently, at block 1205, the server system generates groups of films based on the genre, or some other attribute. Each group of films is also able to be shown on the same screen. For example, a first group related to a first set of documentary films is able to be shown on a first type of screen or projector, and a second group related to a second set of documentary films is able to be shown on a second type of screen or projector. In other words, there may be two or more groups relating to the same genre or attribute based on data format compatibility with a screen or projector.

Following block 1208 is block 1204, which assigns a priority rating to each film. The determination of a priority rating can be implemented according to block 1207.

At block 1209, the server system schedules a priority rating to each group based on priority ratings of films in a given group. For example, if a group that comprises films that are very highly rated, then that group will be assigned a high priority rating. A given group's rating can be determined as a function of one or more of the priority ratings of the films in the group.

At block 1210, the server system automatically schedules the highest priority rated group to a prime date, a prime time block and in the largest screen venue. At block 1211, the server system automatically schedules lower rated groups to one or more of a lower rated date, a lower rated time block, and a smaller screen venue.

Within each scheduled time block for each given group, the server system also automatically schedules the highest priority film to a prime time slot within the given time block, and subsequently schedules a lower rated time film in the group to a lower rated time slot within the same time block. Such operations (block 1212) may be implemented after, or at the same time as blocks 1210 and 1211.

In another aspect, it is recognized that existing computing systems may not effectively manage the transfer of digital film data, especially when filmmakers may be generating DCPs using various technologies. It will be appreciated that the term “DCP” and “DCP file” are herein interchangeably used.

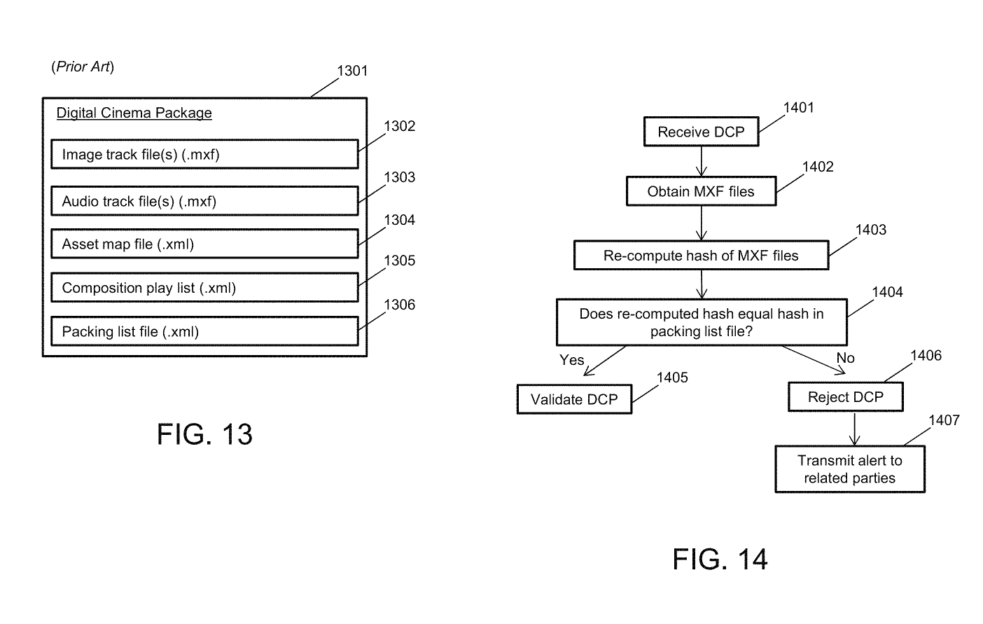

By way of background, as shown in FIG. 13, a DCP 1301 includes one or more image track files 1302 and one or more audio track files 1303, which are of the Material eXchange Format (MXF) data format. The DCP also includes a number of descriptor files that are in the Extensible Markup Language (XML) data format. For example, the XML files include an asset map file 1304, a composition play list file 1305 and a packaging list (PKG) file 1306.

It is herein recognized that filmmakers may use various software technologies to generate a DCP of their film, and that some of these software technologies are inconsistent or operate at a lower quality (i.e. they do not comply with the latest DCI or SMPTE standards, use poor quality image compression schemes, or perform substandard color space conversions). The resulting DCP may be fully or partially incompatible with some or all digital cinema projector devices. Typically, a festival organizer will need to test the screening of a DCP on their projector device to see if it displays properly. This process is time consuming and requires coordinating availability to use the appropriate projector device.

It is also herein recognized that a DCP is subject to bit rot. The digital data will corrupt over time due to various reasons. This phenomenon is also known as data decay and data rot. While a DCP may still play with some data rot, the DCP will fail to play once the bit rot is substantial enough to change the hash of the MXF files. The mismatch of a computed hash and the original hash stored in the packing list file will result in a projector device rejecting the DCP as invalid.

Therefore, it is desirable to automatically test that the DCP file is created properly and to determine that the quality of the DCP is not significantly affected by bit rot.

Turning to FIG. 14, example computer executable instructions are shown that are executed by the server system 110 to automatically validate or reject a DCP. For example, this process is automatically executed as part of the uploading process of a DCP, downloading process of a DCP, or may be manually initiated after film organizer receives a DCP on a computer readable medium.

At block 1401, the server system 110 receives a DCP file. At block 1402, the server system obtains the MXF files from the DCP file. The server system then re-computes a hash of these MXF files (block 1403). The server system compares the re-computed hash with the hash that already exists in the packing list file of the DCP file (block 1404). If the re-computed hash and the existing hash are equal, then the server system marks the DCP file with a validated tag (block 1405). If the hashes are not equal, then the server system marks the DCP file with an invalidated tag and rejects the DCP file (block 1406). The server system transmits an alert message to the related parties (e.g. the film festival organizer and the filmmaker).

In another aspect, it is herein recognized that there may be technical problems when a filmmaker submits an encrypted DCP file.

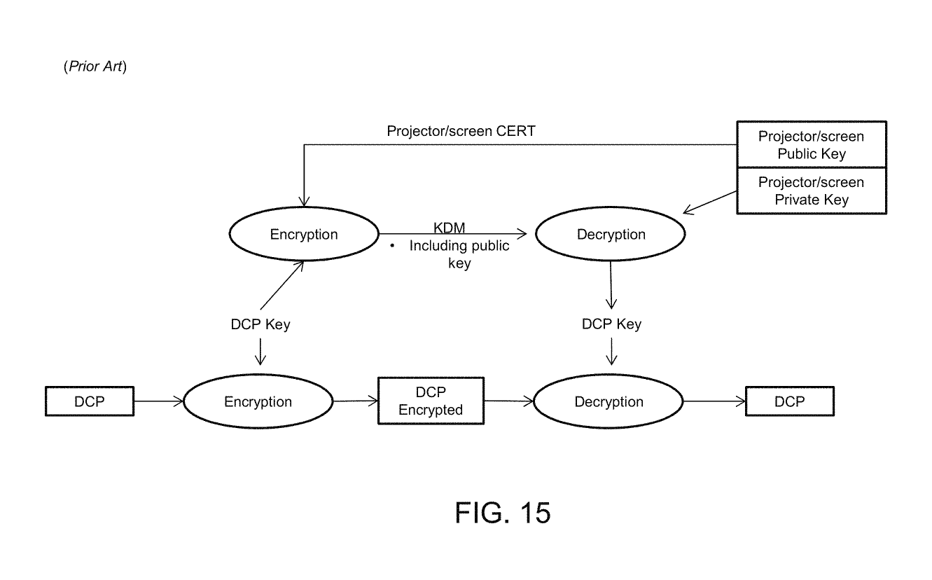

By way of background, as shown in FIG. 15, a DCP file is encrypted using a DCP key, resulting in an encrypted DCP file. The same DCP key is used to decrypt the encrypted DCP file, in order to obtain the unencrypted DCP file. The DCP key is symmetrical key and, in other word, the same key is used to both encrypt and decrypt.

A Public Key Infrastructure (PKI) is used to deliver the DCP key. Each screen (e.g. the server machine or projector device) has a corresponding projector public key and projector private key. The public key is shared or available via a certificate.

A computing system uses the public key from the certificate and the DCP key perform encryption computations to output a Key Delivery Message (KDM).

A computing system, which typically is a different computing system from the one that generated the KDM, uses the KDM and the private key to compute the DCP key. In this way, the DCP key is securely transmitted. The DCP key is then used to decrypt the DCP file.

It is herein recognized that a filmmaker may submit an encrypted DCP file without providing a KDM. In other words, the server system 110 and other computing devices are not able to decrypt the encrypted DCP file.

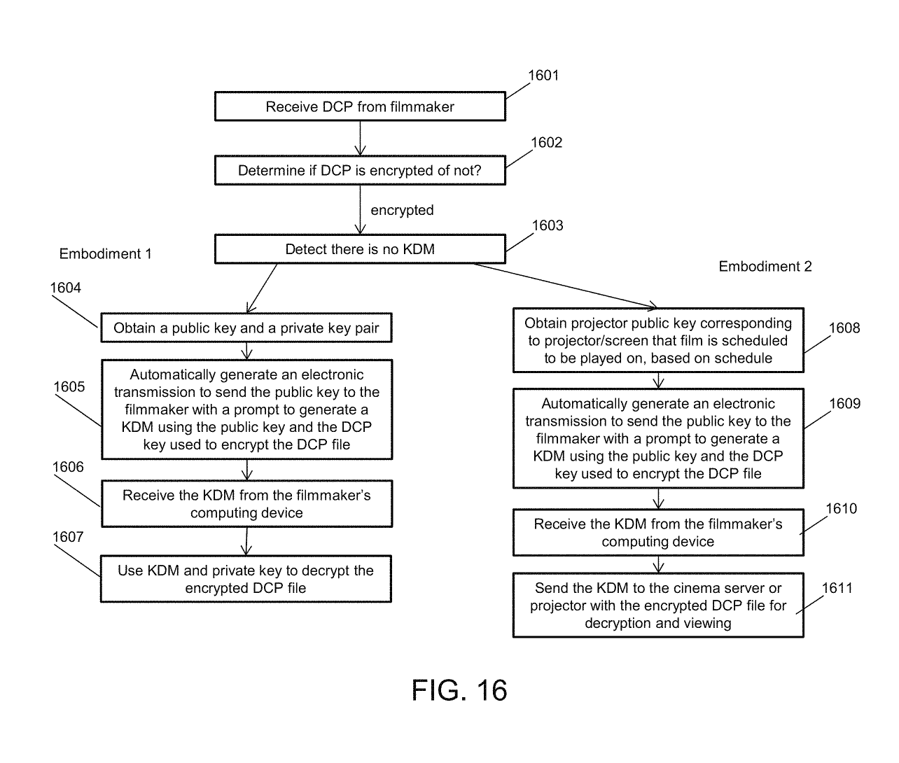

Therefore, the server system 110 executes the example computer executable instructions shown in FIG. 16 to obtain the KDM.

At block 1601, the server system 110 receives a DCP file from a filmmaker. For example, this can be part of the uploader process, a download process, or a process performed after receiving a computer readable medium that stores the DCP file.

At block 1602, the server system determines if the DCP file is encrypted or not. This determination may be made, for example, using a tag in an XML file. If it is encrypted, the server system detects whether or not there is a KDM. In this example, no KDM is detected (block 1603).

In a first example embodiment, the server system obtains a public key and a private key pair (block 1604). At block 1605, the server system automatically generates an electronic transmission (e.g. an email) to send the public key to the filmmaker with a prompt to generate a KDM using the public key and the DCP key used to encrypt the DCP file. At block 1606, the server system receives the KDM from the filmmaker. At block 1607, the server system uses the KDM and the private key to obtain the DCP key, and then uses the DCP key to decrypt the encrypted DCP file.

In another example embodiment, after detecting there is no KDM in the DCP file submission, the server system identifies that projector or screen that the subject film is to be played on, for example, using the electronic calendar. The server system then obtains the projector public key corresponding to that identified projector or screen (block 1608). At block 1609, the server system automatically generates an electronic transmission to send the public key to the filmmaker with a prompt to generate a KDM using the public key and the DCP key used to encrypt the DCP file. At block 1610, the server system receives the KDM. At block 1611, the server system sends the KDM to the cinema server or the projector device associated with the public key, and also sends the encrypted DCP file. In this way, the cinema server or projector device has the data to obtain the DCP key and decrypt the encrypted DCP file.

In another aspect, it also herein recognized that a KDM may be provided with an encrypted DCP file, but that the KDM may not be valid. It is desirable to automatically identify whether the KDM is valid or not.

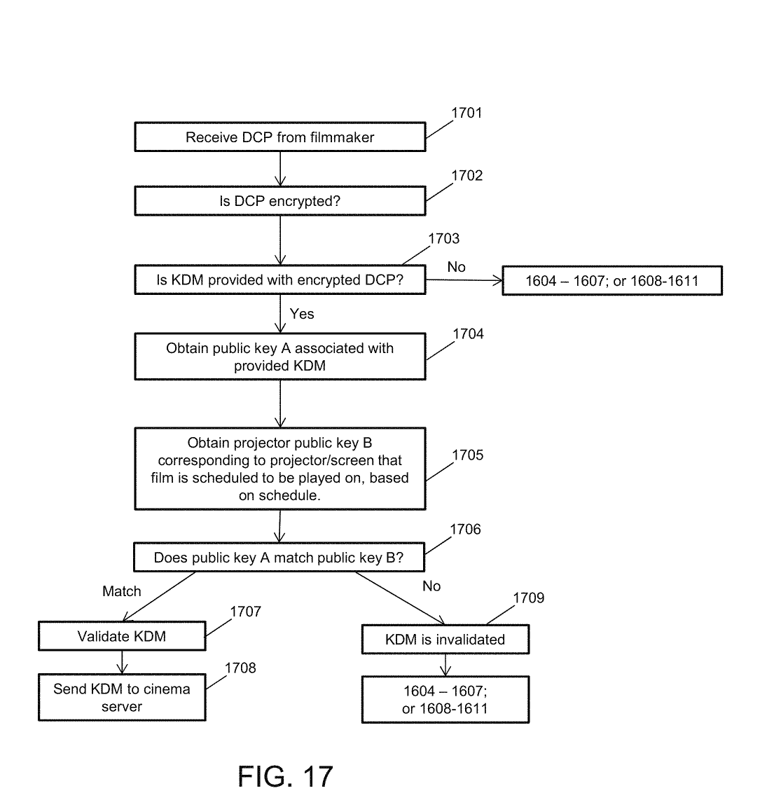

Turning to FIG. 17, the server system 110 receives a DCP file from a filmmaker (block 1701). For example, this can be part of the uploader process, a download process, or a process performed after receiving a computer readable medium that stores the DCP file.

At block 1702, the server system determines if the DCP file is encrypted or not. This determination may be made, for example, using a tag in an XML file. If it is encrypted, as is the case in the example of FIG. 17, then the server system detects whether or not there is a KDM (block 1703). If no KDM is detected, then the process proceeds to block 1604-1607, or blocks 1608-16011.

If a KDM is provided, the server system obtains public key A that is associated with the provided KDM (block 1704). For example, public key A is part of the meta data of the KDM.

At block 1705, the server system determines the projector or screen that the subject film is scheduled to be played on, for example, based on the electronic calendar. The server system then obtains a projector public key B that corresponds to that identified projector or screen.

At block 1706, the server system determines if public key A matches public key B. If they match, then the KDM is validated (block 1707). In an uploading or downloading process, the process is considered successfully completed. The KDM and the encrypted DCP file are sent to the cinema server (block 1708).

If the public keys do not match, then the KDM is invalidated by the server system (block 1709). In an example embodiment, an alert message is sent to the filmmaker. In another example, either in addition or in the alternative, the process proceeds to block 1604-1607, or blocks 1608-1611.

In this way, the KDM is automatically validated or invalidated.

Example embodiments and aspects are of the server system are provided below.

In an example embodiment, a server system for managing digital film data transfer includes: one or more processors; one or more communication devices; and memory that stores a film ID, multiple video data formats, each of the one or more data formats associated with one or more data transfer options, and data format requirements for one or more projectors machines configured to display film data. The server system is configured to: determine a subset of the multiple data formats that are compatible to the data format requirements, the subset comprising one or more allowed data formats; generate a graphical user interface (GUI) that is accessible via the one or more communication devices, the GUI displaying the one or more allowed data formats; receive an input selection via the GUI selecting at least one of the allowed data formats and, in response, determine the one or more data transfer options associated with the selected allowed data format and displaying the same; receive another input selection identifying a selected data transfer option from amongst the one or more data transfer options that are displayed in the GUI; store, in the memory, the selected data transfer option and the selected allowed data format in association with the film ID; and display controls corresponding to the selected data transfer option in the GUI to initiate transfer of the digital film data.

In another example embodiment, a server system for managing digital film data transfer includes: one or more processors; one or more communication devices; and memory that stores an organizer ID, multiple film IDs, an electronic contact address associated with each one of the film IDs. The server system is configured to: generate a given unique ID (UID) corresponding a given film ID and the organizer ID; generate an email account for the given UID, wherein the given UID is part of the email account; generate and send an email to the electronic contact address from the email account, the email comprising a network link to initiate transfer of digital film data corresponding to the UID; detect subsequent data events in relation to the given UID and correspondingly updating a status field; and automatically display and update the status field in a web portal GUI, the status field displayed with information that corresponds to the given UID.

In another example embodiment, a server system for scheduling the playing of digital films, includes: one or more processors; one or more communication devices; and memory that stores a list of films and corresponding film information. The server system is configured to: access memory to obtain the list of films and the corresponding film information; display, in a scheduling graphical user interface (GUI), a given screen; determine and display an electronic calendar in the GUI showing available dates and times associated with the given screen; determine and display with the electronic calendar a subset of the list of films that have compatible data formats with a projector device associated with the given screen; and receive an input via the GUI to assign a film from the displayed subset to a time slot within the electronic calendar.

In an example aspect, the server system is further configured to: receive an input to add generate a pre-event for the assigned film in the electronic calendar, the pre-event scheduled immediately prior to the time slot of the film; receive a time length of the pre-event; and extend an end-time of the time slot of the film by the time length of the pre-event while maintaining a start-time of the time slot of the film.

In another example aspect, a second film is scheduled in a second time slot immediately after the time slot of the film and, responsive to detecting a revision to an end-time of the time slot, the second system automatically adjusts a start-time of the second time slot to immediately follow the revised end-time of the time slot.

In another example aspect, the subset of the list of films includes an entry in the GUI that unifies a group of films, and the group of films is scheduled together into a time slot in the electronic calendar in response to receiving an input selection of the entry.

In another example aspect, the subset of films are displayed in a sequenced list based on priority rating, the priority rating of a given film determined by at least one of an actor rating of an actor in a given film, a director rating of a director of the given film, and a film rating.

In another example embodiment, a server system for obtaining Digital Cinema Package (DCP) files, includes: one or more processors; one or more communication devices; and memory that stores a DCP file, the DCP file comprising Media eXchange Format (MXF) files and a packing list file that includes a hash value. The server system is configured to: access the DCP file to obtain the MXF files and the hash value in the packing list file; compute a new hash value from the MXF files; and, after detecting that the new hash value and the hash value are equal, generate a validated tag that is associated with the DCP file.

In an example aspect, the server system is further configured to, after detecting that the new hash value and the hash value are different, generate a rejection tag that is associated with the DCP file.

In another example embodiment, a server system for obtaining Digital Cinema Package (DCP) files, includes: one or more processors; one or more communication devices; and memory that stores a DCP file that is associated with an electronic contact address. The server system is configured to: detect that the DCP file is encrypted; detect that a Key Delivery Message (KDM) has not been obtained in association with the encrypted DCP file; obtain a public key which corresponds to a private key; automatically generate an electronic message that includes the public key, and send the electronic message to the electronic contact address using the one more communication devices; receive a KDM that was generated using the public key and a DCP key, wherein the DCP key was used to encrypt the encrypted DCP file; and initiate a computing process to obtain the DCP key using the received KDM and the private key.

In another example embodiment, a server system for obtaining Digital Cinema Package (DCP) files, includes: one or more processors; one or more communication devices; and memory that stores a DCP file that is associated with an electronic contact address. The server system is configured to: detect that the DCP file is encrypted; detect that a Key Delivery Message (KDM) and a first public key has been obtained in association with the encrypted DCP file; obtain a second public key corresponding to a projector machine that is assigned to play the DCP file; and, responsive to detecting that the first public key and the second public key match, generate a validated tag that is associated with the KDM.

In an example aspect, the server system is further configured to, responsive to detecting that the first public key and the second public key are different, generate an invalidated tag that is associated with the KDM.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

It is also appreciated that the features described herein may be combined in different ways, even though those combinations are not explicitly described in the context of the example embodiments. The example embodiments are provided to convey the features in an example context, but other different combinations of the described features are also encompassed by the proposed systems and methods.

It will also be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the server system 110, the computing devices in communication thereto, or any component of or related to the server system 110, etc., or accessible or connectable thereto. Any application or module herein described may be implemented using computer readable/executable instructions that may be stored or otherwise held by such computer readable media.

Although the above principles have been described with reference to certain specific examples, various modifications thereof will be apparent to those skilled in the art as outlined in the appended claims.

1. A server system for managing digital film data transfer comprising:
one or more processors;
one or more communication devices;
memory that stores a film ID, multiple video data formats, each of the one or more data formats associated with one or more data transfer options;
the server system configured to at least:
generate a graphical user interface (GUI) that is accessible via the one or more communication devices, the GUI displaying the one or more data formats;
receive an input selection via the GUI selecting at least one of the data formats and, in response, determine the one or more data transfer options associated with the selected data format and displaying the same;
receive another input selection identifying a selected data transfer option from amongst the one or more data transfer options that are displayed in the GUI;
store, in the memory, the selected data transfer option and the selected data format in association with the film ID; and
display controls corresponding to the selected data transfer option in the GUI to initiate transfer of the digital film data.

2. The server system of claim 1 wherein the memory further stores data format requirements for one or more projectors machines configured to display film data; and the server system is further configured to determine a subset of the multiple data formats that are compatible to the data format requirements, the subset comprising one or more allowed data formats, and wherein the GUI displays only the one or more allowed data formats.

3. The server system of claim 1 wherein the one or more data transfer options include uploading the digital film data, digitally linking the digital film data and physically shipping the digital film data.

4. The server system of claim 1 wherein the selected data transfer option comprises digitally linking the digital film data, and the transfer of the digital film data comprises:
the server system receiving a network link for the digital film data;
generating an electronic message to download the digital film data;
downloading the digital film data via the network link; and
updating a status tag in the memory stored in relation to the film ID that the digital film data has been received.

5. The server system of claim 1 wherein the selected data transfer option comprises physically shipping the digital film data, and the transfer of the digital film data comprises:
launching a mailing software program;
generating a mailing label with tracking information;
storing the tracking information; and
receiving and storing mailing status in the memory in relation to the film ID.

6. The server system of claim 1 wherein the server system receives a second input specifying a second data format for the same film ID, and receiving a third input specifying another data transfer option to transferring the digital film data in the second data format.

7. The server system of claim 6 wherein the other data transfer option for transferring the digital film data in the second format is identical to the selected data transfer option for transferring the digital film data in the selected data format.

8. A server system for managing digital film data transfer comprising:
one or more processors;
one or more communication devices;
memory that stores an organizer ID, multiple film IDs, an electronic contact address associated with each one of the film IDs;
the server system configured to:
generate a given unique ID (UID) corresponding a given film ID and the organizer ID;
generate an email account for the given UID, wherein the given UID is part of the email address;
generate and send an email to the electronic contact address from the UID email address, the email comprising a network link to initiate transfer of digital film data corresponding to the UID;
detect subsequent data events in relation to the given UID and correspondingly update a status field; and
automatically display and update the status field in a web portal GUI, the status field displayed with information that corresponds to the given UID.

9. The server system of claim 8 wherein the email further comprises a film title and a film deadline.

10. The sever system of claim 8 wherein the UID comprises the given film ID, an @ character, and the organizer ID.

11. A server system for scheduling the playing of digital films, comprising:
one or more processors;
one or more communication devices;
memory that stores a list of films and corresponding film information;
the server system configured to at least:
access memory to obtain the list of films and the corresponding film information;
displaying, in a scheduling graphical user interface (GUI), a given screen;
determine and display an electronic calendar in the GUI showing available dates and times associated with the given screen;
determine and display with the electronic calendar at least a subset of the list of films; and
receive an input via the GUI to assign a film from the displayed subset to a time slot within the electronic calendar.

12. The server system of claim 11 wherein the server system determines and displays only the subset of the list of films that have compatible data formats with a projector device associated with the given screen.

13. The server system of claim 3 wherein the server system is further configured to:
receive an input to generate a pre-event for the assigned film in the electronic calendar, the pre-event scheduled immediately prior to the film;
receive a time length of the pre-event; and
extend an end-time of the time slot of the film by the time length of the pre-event while maintaining a start-time of the time slot of the film with the pre-event.

14. The server system of claim 11 wherein a second film is scheduled in a second time slot immediately after the time slot of the film and, responsive to detecting a revision to an end-time of the time slot, automatically adjusting a start-time of the second time slot to immediately follow the revised end-time of the time slot.

15. The server system of claim 11 wherein the subset of the list of films includes an entry in the GUI that unifies a group of films, and the group of films is scheduled together into a time slot in the electronic calendar in response to receiving an input selection of the entry.

16. The server system of 11 wherein the subset of films are displayed in a sequenced list based on a priority rating of a given film.

17. The server system of claim 16 wherein the priority rating of the given film is determined by at least one of an actor rating of an actor in a given film, a director rating of a director of the given film, and a film rating.

18. A server system for obtaining Digital Cinema Package (DCP) files, comprising:
one or more processors;
one or more communication devices;
memory that stores a DCP file, the DCP file comprising Media eXchange Format (MXF) files and a packing list file that includes a hash value;
the server system configured to:
access the DCP file to obtain the MXF files and the hash value in the packing list file;
compute a new hash value from the MXF files;
after detecting that the new hash value and the hash value are equal, generate a validated tag that is associated with the DCP file.

19. The server system of claim 18 further configured to, after detecting that the new hash value and the hash value are different, generate a rejection tag that is associated with the DCP file.

20. A server system for obtaining Digital Cinema Packages (DCPs), comprising:
one or more processors;
one or more communication devices;
memory that stores a DCP that is associated with an electronic contact address;
the server system configured to:
detect that the DCP is encrypted;
detect that a Key Delivery Message (KDM) has not been obtained in association with the encrypted DCP;
obtain a public key which corresponds to a private key;
automatically generate an electronic message that includes the public key, and send the electronic message to the electronic contact address using the one more communication devices;
receive a KDM that was generated using the public key and a DCP key, wherein the DCP key was used to encrypt the encrypted DCP; and
initiate a computing process to obtain the DCP key using the received KDM and the private key.

21. A server system for obtaining Digital Cinema Packages (DCPs), comprising:
one or more processors;
one or more communication devices;
memory that stores a DCP;
the server system configured to:
detect that the DCP is encrypted;
detect that a Key Delivery Message (KDM) and a first public key have been obtained in association with the encrypted DCP;
obtain a second public key corresponding to a projector machine that is assigned to play the DCP; and
responsive to detecting that the first public key and the second public key match, generate a validated tag that is associated with the KDM.

22. The server system of claim 21 further configured to, responsive to detecting that the first public key and the second public key are different, generate an invalidated tag that is associated with the KDM.
